(19) United States
(12) Patent Application Publication
(10) Pub. No.: US 2026/0146953 A1
(43) Pub. Date: May 28, 2026

(54) INSECT MIGRATION MONITORING SYSTEM AND METHOD

(71) Applicants: My T. NGUYEN, Tra Vinh City (VN); RYNAN TECHNOLOGIES PTE. LTD., Geylang (SG)

(72) Inventors: My T. NGUYEN, Tra Vinh City (VN); Cuong Q. HONG, Tra Vinh City (VN); Toan Q. TRAN, Cang Long District (VN); Phuong H. SON, Chau Thanh District (VN); Tuan T. LAM, Soc Trang province (VN); Nam Q. DOAN, Chau Phu District (VN); Trang N. DONG, Cang Long District (VN)

(21) Appl. No.: 18/879,915

(22) PCT Filed: Dec. 5, 2023
(86) PCT No.: PCT/IB2023/062259

§ 371 Date: Dec. 30, 2024

(51) Int. Cl. G01N 21/64; A01M 1/02; A01M 1/04

(52) U.S. Cl. CPC G01N 21/6456; A01M 1/026; A01M 1/04; G01N 21/6428; G01N 2201/062

(57) ABSTRACT

An insect monitoring system for luring and capturing insects including a digital camera with dual UV and white LEDs and a processor configured to acquire visual insect data to recognize insect species in conjunction with previously tagged insect groups; and evaluate insect migration and/or dispersion within a habitat range. A method utilizing UV tagging mechanisms for monitoring and predicting insect migration and/or dispersion including providing insect monitoring stations for collecting data indicative of a previously tagged insect groups' presence within a habitat range, providing the data to a server, retrieving previously received data, and determining a change in the data to provide historical, real-time, and predictive information to a user.

### TECHNICAL FIELD

The present disclosure relates to insect monitoring and insect management. Moreover, the present disclosure relates to a system and method for monitoring migratory patterns of insects.

### BACKGROUND

In many regions of the world, agriculture lands being used to grow crops are adversely affected by pests such as insects, which destroy portions of the crops and reduce yield. The global losses of crop production are estimated annually between 20 and 40 percent. Invasive insects and plant diseases cost the global economy around US$290 billion each year.

In many cases, pesticides are used to control pests within an area. However, the use of pesticides such as insecticides is based on information which is typically outdated and not representative of the actual presence of given types of insects within the area at a particular point in time thereby reducing its effectiveness and causing waste or harm to the environment. For instance, many other insects, such as bees and the like, may not adversely affect the crops or may be beneficial by pollinating plants and feeding on the insects which are pests, and these useful insects or arachnids may also be adversely affected by indiscriminate spraying of pesticides.

Integrated pest management (IPM) is an ecological approach to help reduce losses of crop production and reducing plant diseases due to insects through a combination of techniques such as biological control, habitat manipulation, modification of cultural practices, planting with insect resistant varieties, and limiting use of chemical pesticides, while minimizing risks to people and the environment. Identification and monitoring populations of insects and their natural enemies are important components for the implementation of a successful IPM program.

It is further known that certain insects in the wild, especially winged insects and arachnids that utilize wind, may not be range-limited in their habitats. Rather, some such insects clearly migrate or otherwise disperse in predictable patterns over time and through the seasons. However, tracking of pest insects is often a reactionary ad hoc process involving labor-intensive capture and count methods. More recently, such known methods have been enhanced by mark-release-recapture research methods to facilitate manual identification using biological markers such as SmartWater (a traceable liquid taggant from DeterTech UK Limited that, once applied to a surface, leaves a long-lasting and unique identifier and which presence is invisible except under an ultraviolet black light) which has been suggested by Hagler et al. in “Use of a Fluorophore to Tag Arthropods for Mark-Release-Recapture Type Research”, Journal of Insect Science, (2021) 21(6): 20; 1-10, herein incorporated by reference.

Likewise, various known insect tagging techniques include using Day-Glo dust (a product of the DayGlo Color Corp. of Clevland, Ohio, USA), ink dyes, or animal proteins. In the context of fluorescent insect marking, known methods have not been limited to surface taggants. Green fluorescent protein (GFP) variants have been used to identify successful gene transfer as shown by Horn et al. in “Fluorescent Transformation Markers For Insect Transgenesis”, Insect Biochemistry and Molecular Biology 32(2002) 1221-1235, herein incorporated by reference. Indeed, there are known methods of genetic marking related to fluorescent markers for insect transgenesis. Since 2012, the CRISPR method of gene editing has been used for many such purposes.

However, prior insect monitoring systems do not allow proactive IPM implementation considering seasonal and geographical variations in insect location, migration, and dispersion without resorting to labor-intensive methods of migration monitoring. Moreover, reactive IPM implementations require significant pesticidal inventory use and may result in unnecessary pest proliferation.

Furthermore, there is a need in the industry for an improved insect monitoring system that alleviates at least in part the deficiencies of prior insect monitoring systems and seek to solve problems and drawbacks of the prior insect monitoring systems by providing an improved system and method for obtaining insect location, migration, and dispersion information in an efficient and cost-effective manner.

For these and other reasons, there is a need for improvements directed to the effective and efficient insect migration monitoring in terms of proactive IPM.

### SUMMARY

As embodied and broadly described herein, according to a broad aspect, there is provided an insect monitoring system, the system comprising: lure means for attracting insects; an insect inlet proximate to the lure means and for capturing insects; insect retention means for collecting insects having been captured; a conduit extending between the insect inlet and the insect retention means; air displacement means for directing an airflow through the conduit in a direction from the insect inlet to the insect retention means; a camera subsystem including, at least one digital camera configured for capturing at least one of: images of the insect retention means and video of the insect retention means, and a lighting array configured to selectively emit ultraviolet and white light; an on-board processor; and a non-transient storage medium operatively connected to the processor including computer-readable instructions, wherein the processor is configured, upon executing the instructions, to: acquire, under ultraviolet light provided by the lighting array, a first digital representation of the images and video of the insect retention means; perform a fluorescence recognition of fluorescence emitted by the at least one insect type in the first digital representation; apply coordinates corresponding to a detected fluorescence within the first digital representation; acquire, under white light provided by the lighting array, a second digital representation of the images and video of the insect retention means; perform a type recognition of detected insect types among the at least one insect type in the second digital representation; apply coordinates corresponding to the detected insect types within the first digital representation; and identify, by comparison of the first digital representation with the second digital representation, all insect types emitting fluorescence.

As embodied and broadly described herein, according to a broad aspect, there is provided an insect monitoring network comprising, a plurality of insect monitoring systems as described above, and including a server, configured to receive the geocoded data along with the count and type of each insect type emitting fluorescence, a non-transient storage medium configured to store the geocoded data along with the count and type of each insect type emitting fluorescence, and wherein the server is configured to provide data to a user device to cause the user device to display a geographical representation of a distribution pattern of each insect type emitting fluorescence.

The processor may be further configured to generate geocoded data corresponding to a geographical location of the camera subsystem, perform a count of each insect type emitting fluorescence, and provide, over a network, the geocoded data along with the count and type of each insect type emitting fluorescence.

The system may further include a cleaning means for removing insects from the insect retention means, and wherein the processor is further configured to evaluate a density of the insects in the at least one image or video of the insect retention means, provide, over the network, an indication corresponding the density, and in response to the density exceeding a predetermined threshold, actuate the cleaning means.

The system may further include at least one of: a rain sensor, a wind sensor, a temperature sensor, and a humidity sensor.

The lure means may comprise a light or a pheromone diffuser.

The processor may be further configured to provide the at least one of the images and video of the insect retention means over the network.

The instructions may comprise a machine learning algorithm for recognizing insects.

According to a further broad aspect, there is provided a method for monitoring and predicting insect migration across a plurality of locations, the method comprising: providing a plurality of insect monitoring stations across the plurality of locations, the stations each being configured to collect data, the data comprising at least one of: a presence of at least one insect type emitting fluorescence; a number of insects of the at least one insect type emitting fluorescence; a total number of insects; and a geographical location of each of the stations; wherein each of the stations includes a processor configured to provide, over a network, the data to a server, and wherein, for each of the stations, the data is associated a time of gathering; receiving said data by the server and storing the data in a memory; retrieving, by the server, a plurality of previously received data from the memory; determining a distribution pattern for each of the insect types emitting fluorescence based upon the data received from each station and the previously received data associated with a different time of gathering, and storing the distribution patterns in the memory; and providing at least one of the distribution patterns to a user device to cause the user device to display a geographical representation of a migration pattern for the at least one insect type emitting fluorescence.

The method may include that the data collected at each station is obtained by acquiring, under ultraviolet light provided by a lighting array, a first digital representation of the images and video of the at least one insect type emitting fluorescence, performing a fluorescence recognition of fluorescence emitted by the at least one insect species in the first digital representation, applying coordinates corresponding to a detected fluorescence within the first digital representation, acquiring, under white light provided by the lighting array, a second digital representation of the images and video of the insect retention means, performing a type recognition of detected insect types among the at least one insect species in the second digital representation, applying coordinates corresponding to the detected insect types within the first digital representation, and identifying, by comparison of the first digital representation with the second digital representation, all insect types emitting fluorescence.

The above-mentioned performance of fluorescence recognition may be configured to recognize an ultraviolet reactive mechanism pre-applied to one or more tagged insects.

The above-mentioned ultraviolet reactive mechanism may include at least one of: a fluorescent dust, a fluorescent dye, and a fluorescent fluid. The ultraviolet reactive mechanism may also include a genetic modification of the one or more tagged insects.

The above-mentioned lighting array may include one or more light emitting diodes. The lighting array may also include at least one light emitting diode having a tunable wavelength in the range of 345 nm to 700 nm. The lighting array may also include at least one light emitting diode having a wavelength in the range of 345 nm to 399 nm and at least one light emitting diode in the range of 400 nm to 700 nm .

All features of the embodiments that are described in this disclosure and that are not mutually exclusive can be combined with one another. Elements of one embodiment can be used in the other embodiments without further mention. These and other aspects and features of the present invention will now become apparent to those of ordinary skill in the art upon review of the following description of embodiments of the invention in conjunction with the accompanying drawings.

### BRIEF DESCRIPTION OF THE DRAWINGS

A detailed description of the embodiments of the present invention is provided herein below, by way of example only, with reference to the accompanying drawings, in which:

FIGS. 1, 2 and 3 are first, second and third perspective views of an insect monitoring system in accordance with an embodiment.

FIGS. 4 to 6 are enlarged first, second, and third perspective views of the insect monitoring system of FIG. 1 shown without the light source, and the frame surrounding and covering the light source.

FIG. 7 is an enlarged perspective view of the box, pump and fluid source of the insect monitoring system of FIG. 1, the box comprising an inner conduit or receptacle located in the housing defined between first, second, third and fourth walls and the top and bottom end walls of the box, and a plate pivotably mounted to one of the first, second, third and fourth walls of the box and comprising a top surface for receiving the insects, the plate being shown in a first position wherein the plate abuts against the bottom end peripheral wall of the inner conduit or receptacle.

FIG. 8 is a perspective view of the box, pump and fluid source, the plate being shown in a second position wherein the plate no longer abuts against the bottom end peripheral wall of the inner conduit or receptacle and the top surface of the plate is entirely accessible.

FIG. 9 is a perspective view of the box, pump, and fluid source, wherein the fluid source generates a spray of fluid towards the top surface of the plate that is in the second position.

FIG. 10 is a perspective view of the box, pump, fluid source, and a cleaning member pivotably mounted to one of the first, second, third and fourth walls of the box, the cleaning member being shown in a second position wherein the cleaning member begins contacting the top surface of the plate for one or both cleaning the top surface of the plate and removing insects located on the top surface of the plate.

FIG. 11 is a perspective view of the box, pump and fluid source, the cleaning member being shown in the second position wherein the cleaning member ends contacting the top surface of the plate for one or both cleaning the top surface of the plate and removing insects located on the top surface of the plate.

FIG. 12 is a perspective view of the box, pump, and fluid source, wherein the pump and the cover of the fluid source are shown differently.

FIG. 13 is an enlarged exploded view of the cleaning member.

FIG. 14 is a perspective view of the box comprising a plate mounting mechanism according to another embodiment.

FIG. 15 is a perspective view of the box of FIG. 14 with an exploded view of the plate, the cleaning member, and the plate mounting mechanism according to the other embodiment.

FIG. 16 is an enlarged exploded view of a camera subsystem of the insect monitoring system.

FIG. 17 is a schematic representation of a portion of an on-board insect monitoring system comprising network integration.

FIG. 18 is a representation of an exemplary insect monitoring network.

FIG. 19 is a method for insect monitoring and predicting insect population trends.

FIG. 20 is a photographic scenario when the LEDs selectively emit UV light from the lighting array of the camera subsystem.

FIG. 21 is a photographic scenario when the LEDs selectively emit white light from the lighting array of the camera subsystem.

FIGS. 22 and 23 show enlarged images of identical grouping of previously UV-tagged insects under white and UV light, respectively.

FIG. 24 is a series of illustrations showing the process of applying image filtering with regard to a captured image with no fluorescent markers.

FIG. 25 is a series of illustrations showing the process of applying image filtering with regard to a captured image including fluorescent markers.

FIG. 26 illustrates a machine learning pipeline in accordance with one embodiment of the present insect migration monitoring system and method.

FIG. 27 is a diagram illustrating the overall operating procedure of the present insect migration monitoring system.

In the drawings, embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION OF EMBODIMENTS

To facilitate the description, any reference numeral designating an element in one figure will designate the same element if used in any other figures. In describing the embodiments, specific terminology is resorted to for the sake of clarity, but the invention is not intended to be limited to the specific terms so selected, and it is understood that each specific term comprises all equivalents. Variants, examples, and preferred embodiments of the invention are described hereinbelow.

Before any variants, examples or preferred embodiments of the invention are explained in detail, it is to be understood that the invention is not limited in its application to the details of construction and the arrangement of components set forth in the following description or illustrated in the drawings. The invention is capable of other variants or embodiments and of being practiced or of being carried out in various ways.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional suitable items. Unless specified or limited otherwise, the terms “mounted,” “connected,” “supported,” and “coupled” and variations thereof are used broadly and encompass both direct and indirect mountings, connections, supports, and couplings and are thus intended to include direct connections between two members without any other members interposed therebetween and indirect connections between members in which one or more other members are interposed therebetween. Further, “connected” and “coupled” are not restricted to physical or mechanical connections or couplings. Additionally, the words “lower”, “upper”, “upward”, “down” and “downward” designate directions in the drawings to which reference is made. Similarly, the words “left”, “right”, “front” and “rear” designate locations or positions in the drawings to which reference is made. The terminology includes the words specifically mentioned above, derivatives thereof, and words or similar import.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure. Similarly, the terms “inwardly,” “outwardly” and “radially” generally refer to the orientation of a surface relative to its axis of elongation, or axis of rotation, as appropriate. Unless otherwise defined, all technical and scientific terms used herein have the same meaning as commonly understood by one of ordinary skill in the art.

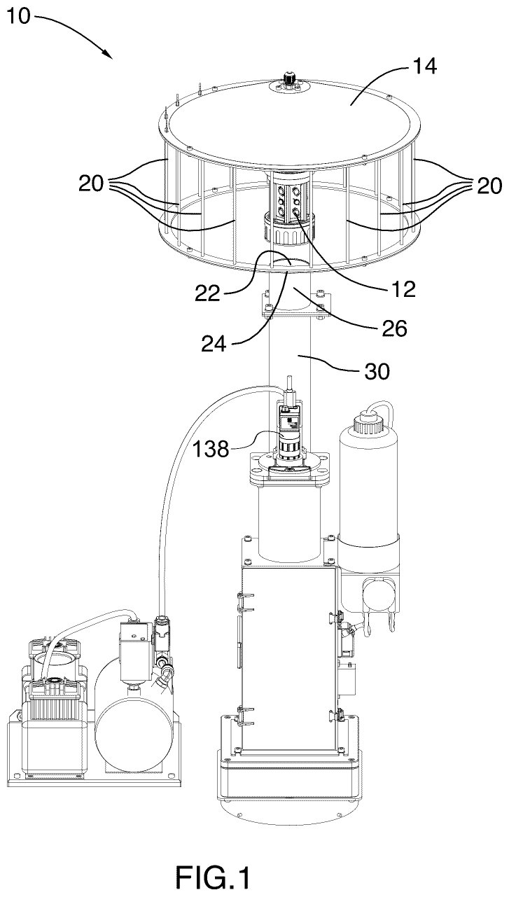

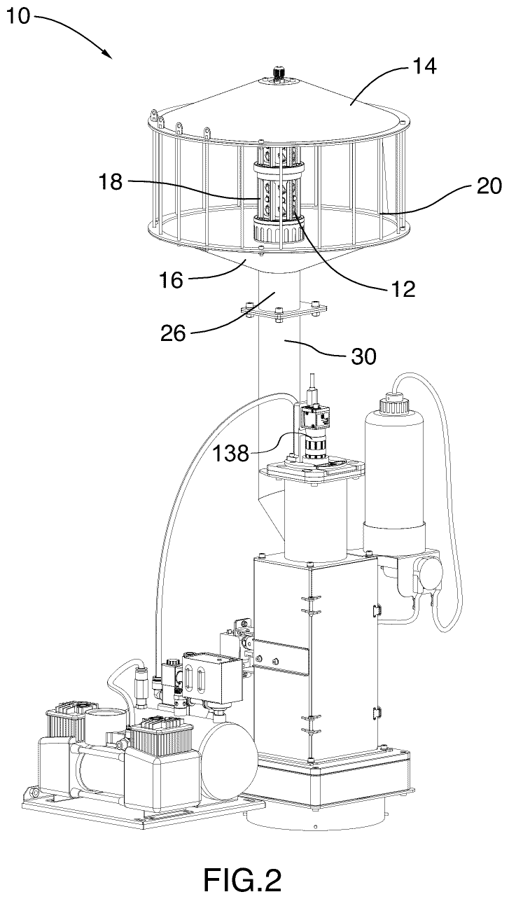

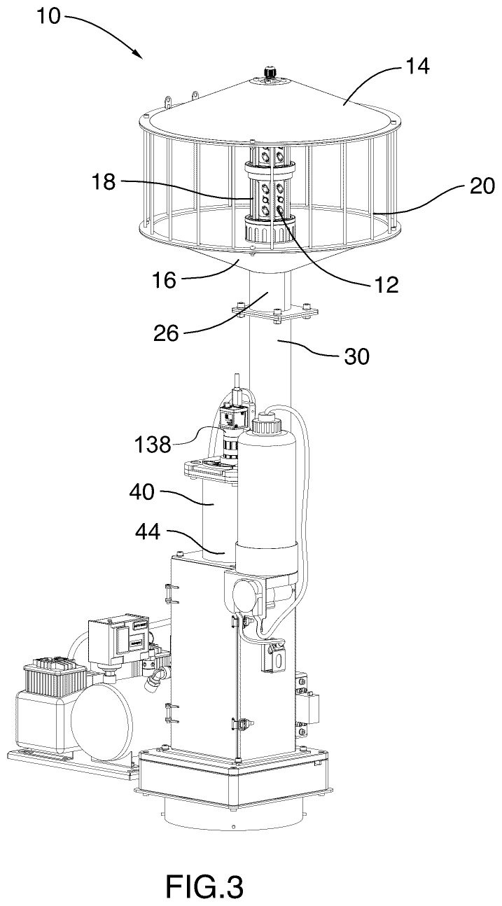

FIGS. 1, 2 and 3 show an insect monitoring system 10 in accordance with an embodiment.

The insect monitoring system 10 comprises a light source 12 for attracting insects. The light source 12 may be an insect luring lamp including a set of light-emitting diode (LEDs) for attracting the insects. It will be appreciated that while the insect luring lamp comprises LEDs, the insect luring lamp may comprise other types of light emitting devices such as incandescent bulbs, fluorescent lamps, halogen lamps, compact fluorescent lamps (CFL), and the like. The insect luring lamp may comprise a set of LEDs 250 with 12 ultraviolet (UV) LEDs (3W, 380 nm ) and 6 LEDS emitting in the red, green, and blue color spectrum (3W). It will be appreciated that the set of LEDs 250 may comprise a different number of LEDs which emit in a range of 345 to 650 nm. A given one of the set of LEDs 250 may selectively emit light in a plurality of wavelengths.

The insect monitoring system 10 may comprise a roof comprising one or more solar panels mounted to the pole. In one or more embodiments, the pole and/or stand may be buried under the ground to prevent movement and improve stability of the insect monitoring system 10. The roof may comprise an anti-lightning rod made of copper, a wind vane, a rain gauge sensor, and an anemometer. It will be appreciated that one or more of the anti-lightning, wind vane, rain gauge sensor, and anemometer may be optional.

Moreover, a solar power generation and a storage subsystem may be provided. The solar power generation and storage subsystem may comprise a solar converter that regulates electricity produced by the solar panels and relayed to the solar converter via electrical conductors such that it may be stored in a battery for providing electrical energy to power at least partially the insect monitoring system 10.

Furthermore, an electronics subsystem may also be provided. The electronics subsystem may comprise one or more controller, relays, current and voltage regulators, GPS modules, network interfaces, as well as the LEDs to which the electronics subsystem is connected via a multi-conductor power cable or other suitable connection means. The GPS module may enable locating the insect monitoring system 10 and the network interface may enable connecting the insect monitoring system 10 to a communications network via the networking device for transmission and reception of data. It will be appreciated that one or more components of the electronics subsystem may be optional. The electronics subsystem may comprise a processor operatively connected to a non-transitory storage medium which may be used as a computer and/or for other purposes.

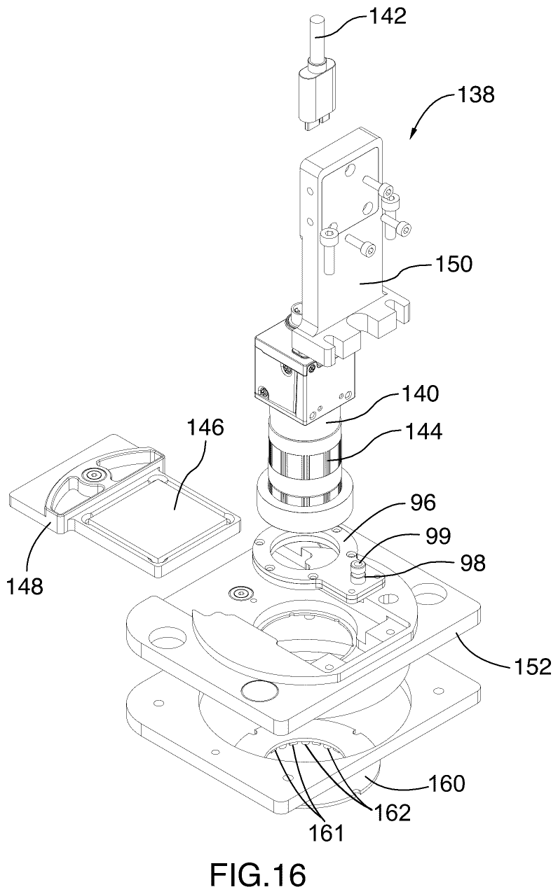

It is understood that one or more controllers may be provided and one or more of the controllers may be operatively connected to each of, some of, or all components of the insect monitoring system 10 and such components may comprise one or more light sources, one or more compressed air sources, one or more fans, one or more insect collecting devices or plates, one or more cleaning devices or members, one or more fluid sources, one or more containers or reservoir, one or more pumps, one or more compressors, and one or more cameras. Indeed, a camera subsystem 138 as shown is provided and described further hereinbelow in more detail with regard to FIG. 16.

Referring to FIGS. 1 to 3, the insect monitoring system 10 comprises a top cover 14 located above the light source 12 and a conical bottom cover 16 located below the light source 12, the light source 12 being mounted centrally between the top and bottom covers 14, 16. Surrounding the light source 12, the insect monitoring system 10 may comprise a plurality of spaced-apart vertical bars 18 for protecting the light source 12. Similarly, the insect monitoring system 10 may comprise a plurality of spaced-apart vertical bars 20 between the top and bottom covers 14, 16 for surrounding and protecting the light source 12. The vertical bars 20 may define a fence for preventing vandalism of the insect monitoring system 10 and/or of the light source 12. The top and bottom covers 14, 16 and the vertical bars 18, 20 may be made of galvanized metal. The height of the bars 20 may be lower than the height of the light source 12 to enable insects to fly freely towards the light source 12 when the LEDs are activated, and to prevent spider webs from catching insects when insects fly towards the light source 12. The bars 20 may be positioned vertically with a spacing between about 5 cm and about 15 cm between each bar 20 for facilitating periodical cleaning of spider webs. It will be appreciated that other configurations of the bars 20 may be possible.

The conical bottom cover 16 defines an outlet opening in communication with an inlet opening 22 defined by a top inlet peripheral wall 24 of a top conduit 26. The top conduit 26 comprises a peripheral wall 28 defining a moving area for the insects such that insects attracted by the light source 12 move into the inlet opening 22 of the top conduit 26, and through the moving area of the top conduit 26.

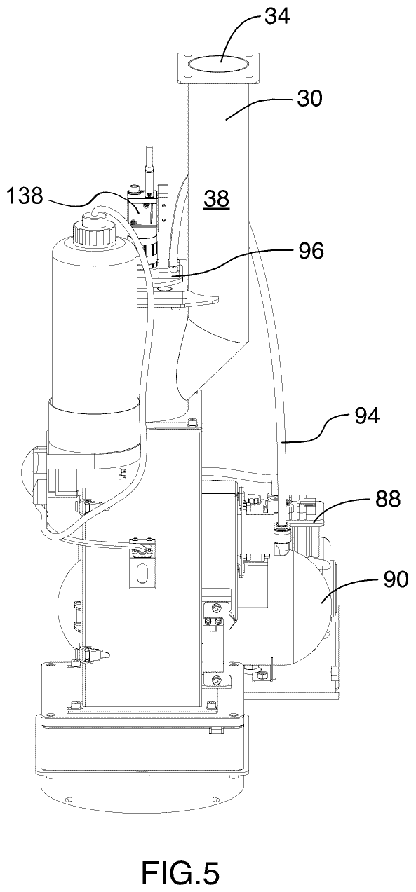

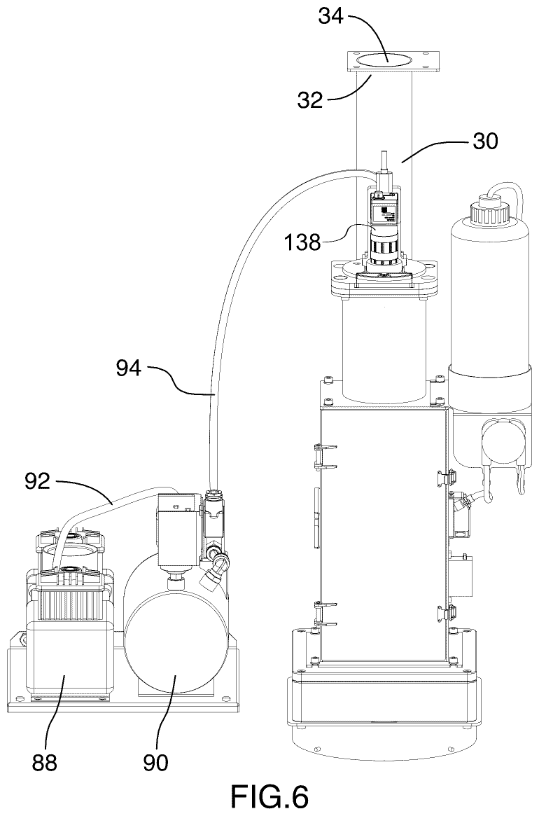

Referring to FIGS. 1 to 6, the insect monitoring system 10 comprises a first conduit 30 comprising a first inlet end wall 32 defining a first inlet opening 34 adjacent and/or below the light source 12 and a first outlet end wall 36 defining a first outlet opening in communication with the first inlet opening 34. The first inlet end wall 32 may be a first top inlet wall and the first outlet end wall 36 may be a first bottom end wall. The first conduit 30 comprises a first peripheral wall 38 defining a first moving area for the insects such that insects attracted by the light source 12 move into the inlet opening 22 of the top conduit 26, through the moving area of the top conduit 26, and through the first moving area of the first conduit 30.

The insect monitoring system 10 also comprises a second conduit 40 comprising a second inlet end wall, a second peripheral wall 42 defining a second inlet opening in communication with the first outlet opening of the first conduit 30 and a second outlet end wall 44 defining a second outlet opening in communication with the second inlet opening of the second conduit 40. The second inlet end wall may be a second peripheral or side inlet wall and the second outlet end wall 44 may be a second bottom end wall. The second conduit 40 defines a second moving area for the insects such that insects attracted by the light source 12 move into the inlet opening 22 of the top conduit 26, through the moving area of the top conduit 26, through the first moving area of the first conduit 30, and through the second moving area of the second conduit 40.

It is understood that the first and second conduits 30, 40 may rather be or rather define a conduit, tube or pipe comprising an inlet end wall or top inlet end wall defining an inlet opening adjacent and/or below the light source and an outlet end wall or bottom outlet end wall defining an outlet opening in communication with the inlet opening, wherein the conduit, tube or pipe comprises a peripheral wall defining a moving area for the insects between the inlet and outlet openings of the conduit, tube or pipe and/or wherein the conduit, tube or pipe defines a moving area for the insects between the inlet and outlet openings of the conduit, tube or pipe, such that insects attracted by the light source 12 move into the inlet opening of the conduit, and through the moving area of the conduit, tube or pipe.

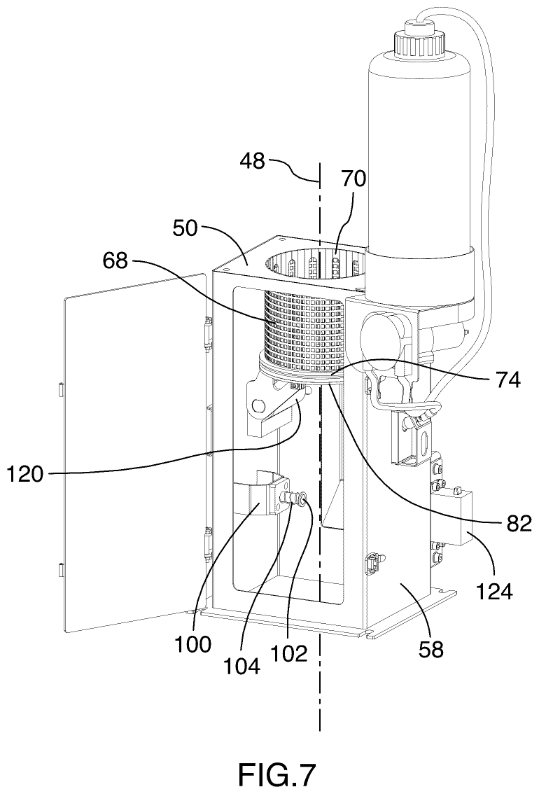

As best shown in FIGS. 7 to 12, the insect monitoring system 10 comprises a box 46 extending along a longitudinal or vertical axis 48 between a top end wall 50 and a bottom end wall 52. The box 46 defines a housing 54 between first, second, third and fourth longitudinal or left, right, front and rear vertical walls 56, 58, 60, 62 and the top and bottom end walls 50, 52. The top end wall 50 defines a top opening 64 and the front wall 60 defines an opening 66 for allowing access into the box 46 and/or the housing 54 for cleaning purposes and/or for components maintenance purposes. The box 46 may comprise a door for covering the opening 66.

The box 46 may be mounted to a pole that is supported and maintained upright and a stand may be added to support the pole. Each of the box 46, the pole and the stand may be made from galvanized metal. Alternatively, the box 46 may be mounted to a frame made of galvanized metal or stainless steel, and the frame may be mounted to the pole.

The box 46 comprises a box conduit 68 extending along the longitudinal or vertical axis 48 of the box 46 and comprising an inlet end wall 70 defining a receptacle inlet opening 72 in communication with the top opening 64 of the box 46 and the second outlet opening defined by the second outlet end wall 44 of the second conduit 42 and an outlet end wall 74 defining a receptacle outlet opening 76 in communication with the receptacle inlet opening 72. The box conduit 68 comprises a receptacle peripheral wall 78 defining a receptacle moving area 80 for the insects such that insects attracted by the light source 12 move into the inlet opening 22 of the top conduit 26, through the moving area of the top conduit 26, through the first moving area of the first conduit 30, through the second moving area of the second conduit 40, and through the receptacle moving area 80 of the box conduit 68.

It is understood that the first and second conduits 30, 40 and the box conduit 68 may rather be or rather define a conduit, tube or pipe comprising an inlet end wall or top inlet end wall defining an inlet opening adjacent and/or below the light source and an outlet end wall or bottom outlet end wall defining an outlet opening in communication with the inlet opening, wherein the conduit, tube or pipe comprises a peripheral wall defining a moving area for the insects between the inlet and outlet openings of the conduit, tube or pipe and/or wherein the conduit, tube or pipe defines a moving area for the insects between the inlet and outlet openings of the conduit, tube or pipe, such that insects attracted by the light source 12 move into the inlet opening of the conduit and through the moving area of the conduit, tube or pipe.

Referring to FIGS. 7 to 11, the box 46 of the insect monitoring system 10 comprises a plate 82 pivotably mounted to one of the first, second, third and fourth longitudinal or left, right, front, and rear vertical walls 56, 58, 60, 62 of the box 46. The plate 82 comprises a bottom surface 84 and an opposed top surface 86.

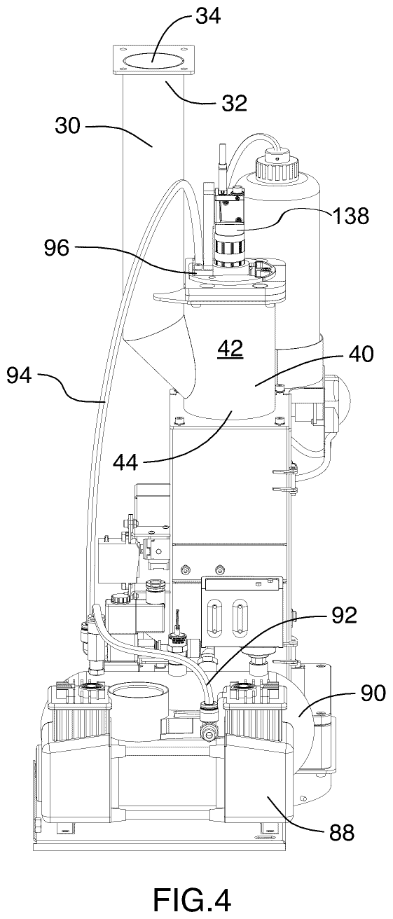

Referring to FIGS. 4 to 6, the insect monitoring system 10 comprises a compressed air source for generating compressed air and an airflow in one or both of the second and box conduits 42, 68 for moving downwardly the insects and for maintaining in place the insects against the top surface 86 of the plate 82.

In one embodiment, the compressed air source comprises a compressor 88, a compressed air source container or reservoir 90 connected to the compressor 88, a first tube 92 between the compressor 88 and the compressed air source container or reservoir 90, and a second tube 94 between the compressed air source container or reservoir 90 and a top plate 96. As best seen in FIGS. 4, 5 and 16, the top plate 96 comprises a tube connector 98 adapted to receive the distal end peripheral wall of the second tube 94 and defining an inner hole or aperture 99 such that the airflow generated by the compressed air source 90 passes through that inner hole or aperture 99 for applying downward pressure in one or both of the second conduit 40 and the box conduit 68, for moving downwardly the insects and for maintaining in place the insects against the top surface 86 of the plate 82.

It is understood that the insect monitoring system 10 may rather comprise a fan for applying downward pressure in one or both of the second conduit 40 and the box conduit 68 and/or another compressed air source container or reservoir connected to the compressor 88 or to another compressor for applying additional downward pressure in one or both of the second conduit 40 and the box conduit 68 for moving downwardly the insects and for maintaining in place the insects against the top surface 86 of the plate 82.

Referring to FIG. 7, when the plate 82 is in a first position, the plate 82 abuts against the outlet end wall 74 of the box conduit 68. Because downward pressure is applied by the airflow in one or both of the second conduit 40 and the box conduit 68, in the receptacle moving area 80 of the box conduit 68, the insects are pushed against the plate 82 and are maintained in place on the top surface 86 of the plate 82. The box conduit 68 may also be construed as a receptacle wherein the insects are received, pushed against the plate 82, and maintained in place on the top surface 86 of the plate 82.

The airflow, flow or velocity generated by the compressor air source or the fan may have a speed between 50 liters per minute (l/min) and 65 l/min and a pressure generated by the compressor air source may be between 35 psi and 45 psi in in one or both of the second conduit 40 and the box conduit 68 when the plate 82 is in a first position and abuts against the outlet end wall 74 of the box conduit 68.

It is understood that the inlet opening 22 of the top conduit 26, the moving area of the top conduit 26, the first moving area of the first conduit 30, the second moving area of the second conduit 40, the receptacle moving area 80 of the box conduit or receptacle 68 and the plate 82 are sized and shaped to receive insects of various size.

Once the insects located and maintained on the plate 82 have been monitored, identified, analyzed and/or once images of the insects have been captured and/or recorded, these insects must leave or exit the box conduit or receptacle 68 such that other insects attracted by the light source 12 move into the inlet opening 22 of the top conduit 26, through the moving area of the top conduit 26, through the first moving area of the first conduit 30, through the second moving area of the second conduit 40, and through the receptacle moving area 80 of the box conduit or receptacle 68, may be monitored, identified, analyzed and/or images of these other insects may be captured and/or recorded.

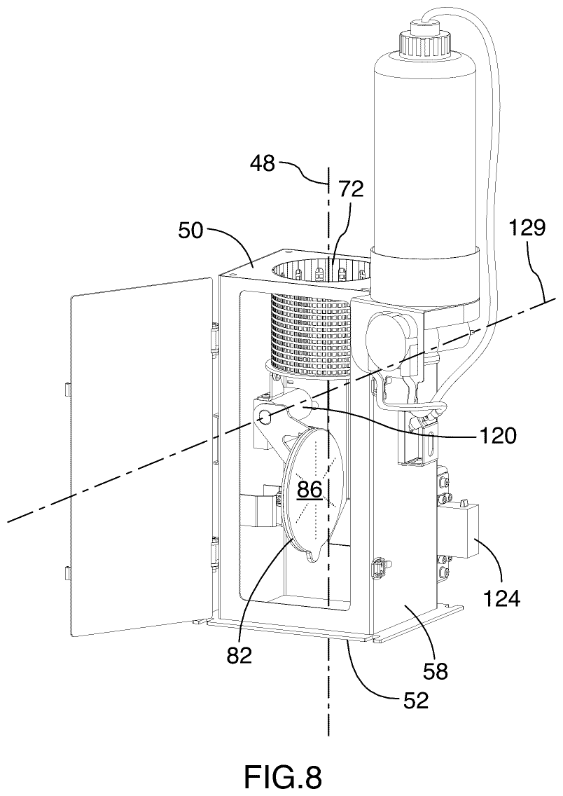

The plate 82 is thus pivotably mounted to one of the first, second, third and fourth longitudinal or left, right, front, and rear vertical walls 56, 58, 60, 62 of the box 46 between the first position shown in FIG. 7 to a second position shown in FIG. 8.

In the second position, the plate 82 no longer abuts against the outlet end wall 74 of the box conduit or receptacle 68 and the top surface 86 of the plate 82 is entirely accessible. Moreover, in the second position, the insects that were maintained in place on the top surface 86 of the plate 82 would fall and/or would be pushed away from the plate 82.

It is understood that an exhaust, an exhaust fan, or a vacuum source may be provided in the box 46 or outside the box 46 for evacuating or exiting the insects from the box 46.

As best shown in FIG. 7, the box 46 may comprise an abutting member 100 to the one of the first, second, third and fourth longitudinal or left, right, front and rear vertical walls 56, 58, 60, 62 of the box 46 with an abutting projection 102 against which the plate 82 abuts in the second position and a spring 104 for inwardly biasing the abutting projection 102.

It is understood that the plate may be a plate comprising a plurality of apertures, the apertures being large enough to allow airflow through the plate and small enough to trap insects thereon by airflow pressure and/or to maintain in place the insects onto the top surface of the plate by airflow pressure. For instance, the plate may comprise a body that comprises top and bottom surfaces and a peripheral wall, the body comprising a plurality of apertures. The plate may also define a mesh or a screen plate. It is also understood that the plate may comprise a body that comprises top and bottom surfaces and a peripheral wall, the peripheral wall comprising one or more longitudinal indentations, notches or recesses defining one or more spaces between the plate body and the internal peripheral wall of the receptacle, the space or spaces being sized to allow airflow for maintaining in place the insects onto the top surface of the plate body while preventing insects to pass through the space or spaces. The plate may be made of a variety of materials such as aluminum, stainless steel, galvanized metal, or plastic allowing prolonged used and durability.

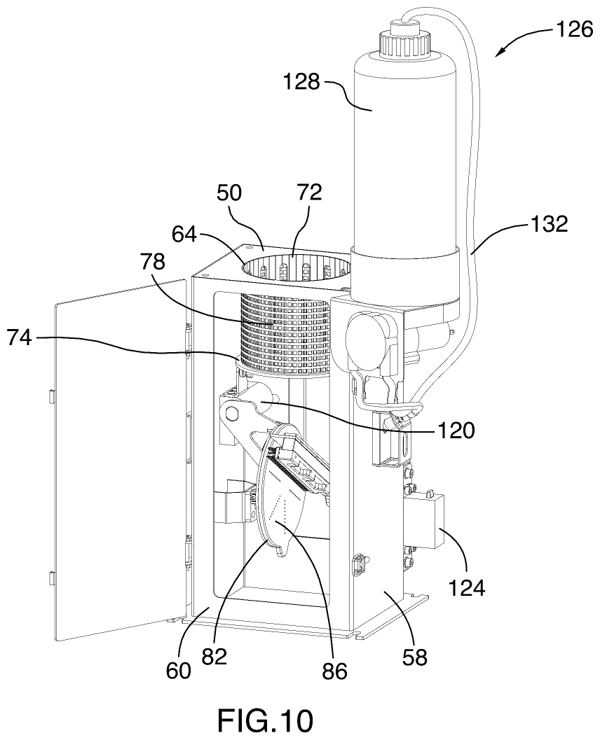

Referring to FIGS. 10, 11, 12, 14 and 15, the insect monitoring system 10 comprises a cleaning member 106 pivotably mounted to one of the first, second, third and fourth longitudinal or left, right, front and rear vertical walls 56, 58, 60, 62 of the box 46 between first and second positions.

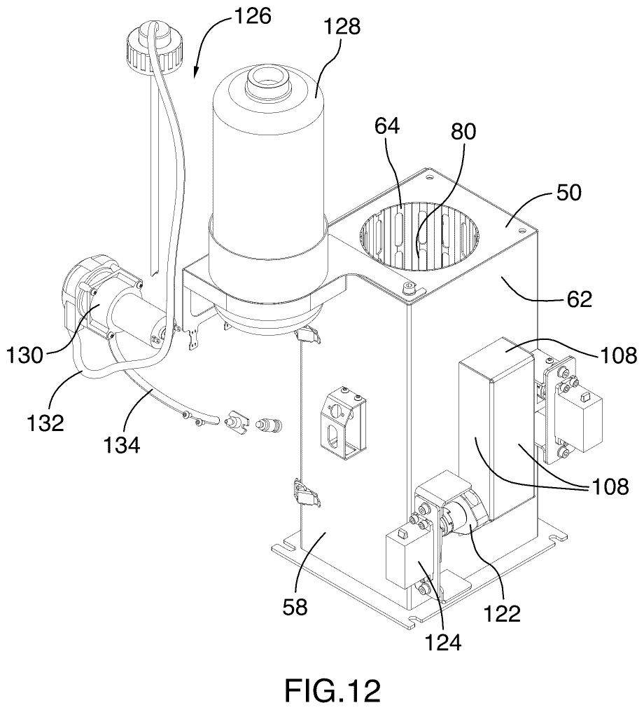

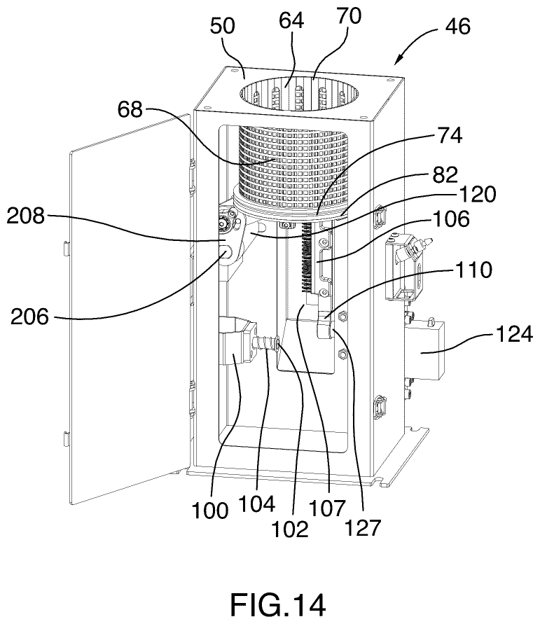

Referring to FIGS. 12 and 14, in the first position, the cleaning member 106 is adjacent the one the first, second, third and fourth longitudinal or left, right, front, and rear vertical walls 56, 58, 60, 62 of the box 46. The cleaning member 106 may be adjacent the rear vertical wall 62 or may be at least partially received in an inner housing 107 defined by projecting walls 108 of the rear vertical wall 62 of the box 46.

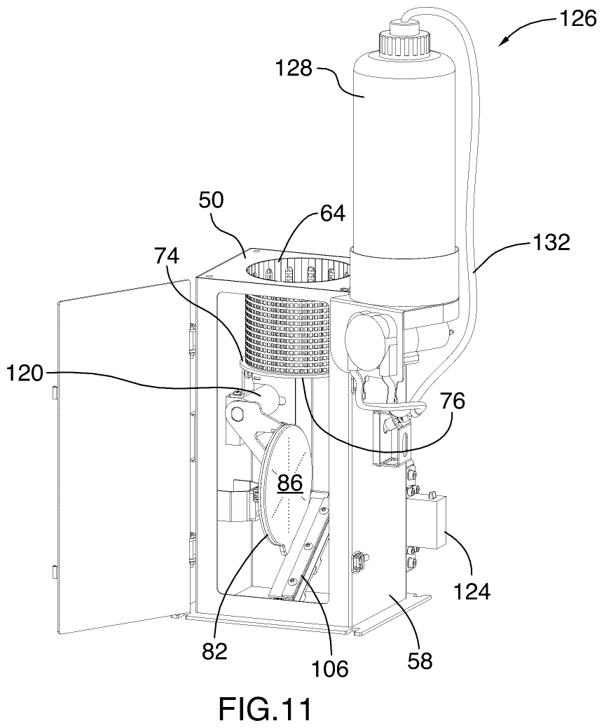

Referring to FIGS. 10 and 11, in the second position, the cleaning member 106 contacts the top surface 86 of the plate 82 for one or both cleaning the top surface 86 of the plate 82 and removing insects located on the top surface 86 of the plate 82.

In FIG. 10, the cleaning member 106 begins contacting the top surface 86 of the plate 82 for one or both cleaning the top surface 86 of the plate 82 and removing insects located on the top surface 86 of the plate 82.

In FIG. 11, the cleaning member 106 ends contacting the top surface 86 of the plate 82 for one or both cleaning the top surface 86 of the plate 82 and removing insects located on the top surface 86 of the plate 82.

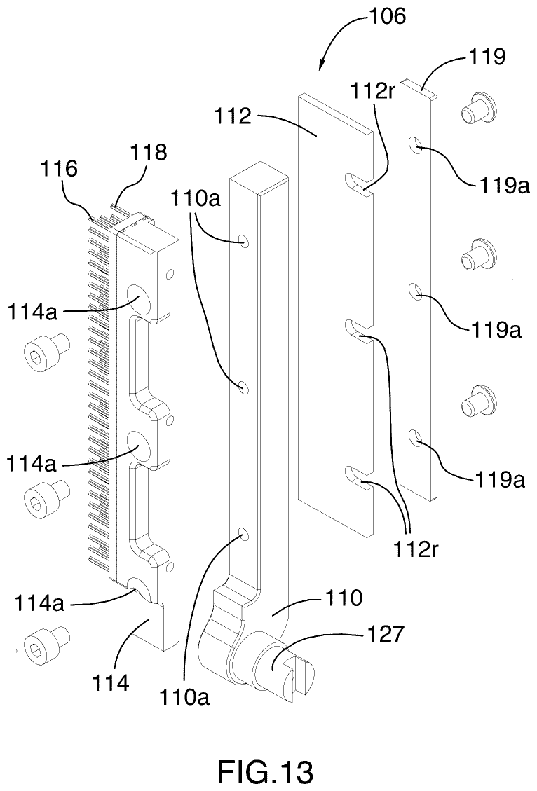

Referring to FIGS. 13, 14 and 15, the cleaning member 106 comprises an elongated base member 110 with an elongated blade, an elongated flexible blade, or an elongated wiper 112. The elongated base member 110 also comprises an elongated brush 114 extending parallel to the elongated blade, elongated flexible blade, or elongated wiper. The elongated brush 114 may comprise first and second rows 116, 118 each comprising a plurality of bristles, hairs, or wire sets. The clearing member 106 may also comprise an elongated support 119 defining first, second and third apertures 119a. Moreover, the elongated wiper 112 may define first, second and third recesses 112r aligned with the first, second and third apertures 119a, the elongated base member 110 may define first, second and third apertures 110a aligned with the first, second and third recesses 112r, and the elongated brush 114 may define first, second and third apertures 114a aligned with the first, second and third apertures 110a. Furthermore, the cleaning member 106 may comprise first, second and third connectors for affixing the elongated support 119 and the elongated wiper 112 to an inner side of the elongated base member 110, fourth, fifth and sixth connectors for affixing the elongated brush 114 to an outer side of the elongated base member 110, and a connecting projection 127 extending transversely from the elongated base member arm 110.

Referring to FIGS. 7, 8, 10, 11, 12, 14 and 15, the insect monitoring system 10 may comprise a first servo motor 120 connected to the plate 82 via a pivoting arm for pivoting the plate 82 between the first position shown in FIG. 7 and the second position shown in FIG. 8 and a second servo motor 122 connected to the cleaning member 106 via the connecting projection 127 for pivoting the cleaning member 106 between the first position shown in FIG. 14 and the second position shown in FIGS. 10 and 11. The insect monitoring system 10 may also comprise a controller 124 adapted to activate and deactivate the second servo motor 122 of the cleaning member 106.

As shown in FIG. 8, the first servo motor 120 is mounted to the one the first, second, third and fourth longitudinal or left, right, front and rear vertical walls 56, 58, 60, 62 of the box 46 and extends along a transversal or horizontal axis 129 that intersects the longitudinal or vertical axis 48 of the box 46.

As shown in FIGS. 12, 14 and 15, the second servo motor 122 may be mounted to a first side of a support mounted to the rear vertical wall 62 of the box 46 and the controller 124 may be mounted to a second side of the support, the controller being operatively connected to the second servo motor 122 at a first end of the servo motor 122, and the second servo motor 122 being operatively connected to the connecting projection 127 of the cleaning member 106 at a second end. The connecting projection 127 of the cleaning member 106 and the second servo motor 122 extend along a transversal or horizontal axis that intersects the longitudinal or vertical axis 48 of the box 46.

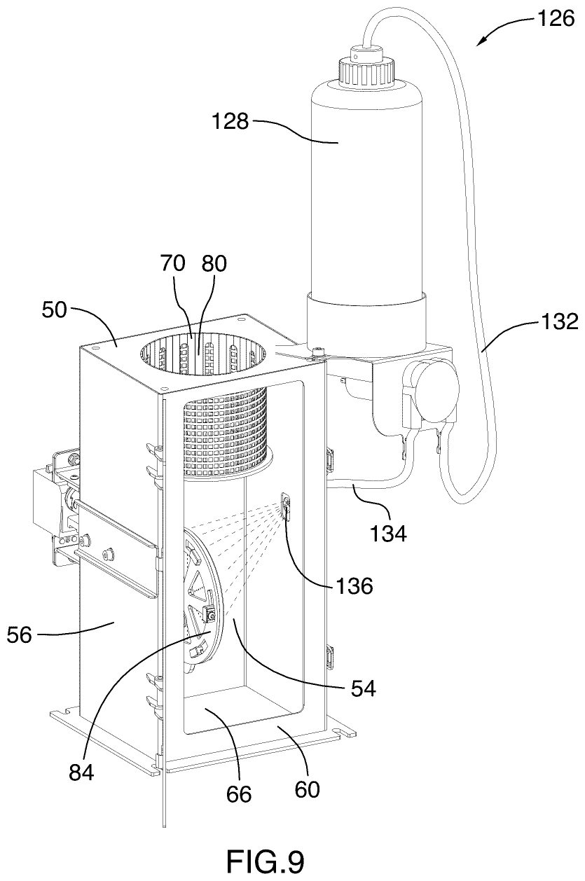

Referring to FIGS. 7 to 12, the insect monitoring system 10 comprises a fluid source 126 mounted to one of the first, second, third and fourth walls of the box. As best shown in FIG. 9, the fluid source 126 is adapted to generate a spray of fluid towards the top surface 86 of the plate 82 when the plate 82 is in the second position. The fluid source 126 may comprise a fluid container or reservoir 128, a pump 130 in fluid communication with the fluid container or reservoir 128 through a first fluid tube 132 and in fluid communication with a second fluid tube 134, the second fluid tube 134 comprising a distal peripheral end wall 136 mounted to one of the first, second, third and fourth longitudinal or left, right, front and rear vertical walls 56, 58, 60, 62 of the box 46, the distal peripheral end wall 136 defining a fluid outlet through which the fluid is directed towards the top surface 86 of the plate. The spray of fluid generated by the pump 130 may have a flow, a velocity, or a speed between 35 ml/min and 50 ml/min or may create a pressure within the second fluid tube 134 between 10 psi and 20 psi, for example between 14 psi and 16 psi. The fluid may be water, water mixed with soap, water mixed with liquid detergent, or any suitable fluid allowing cleaning of the top surface 86 of the plate 82.

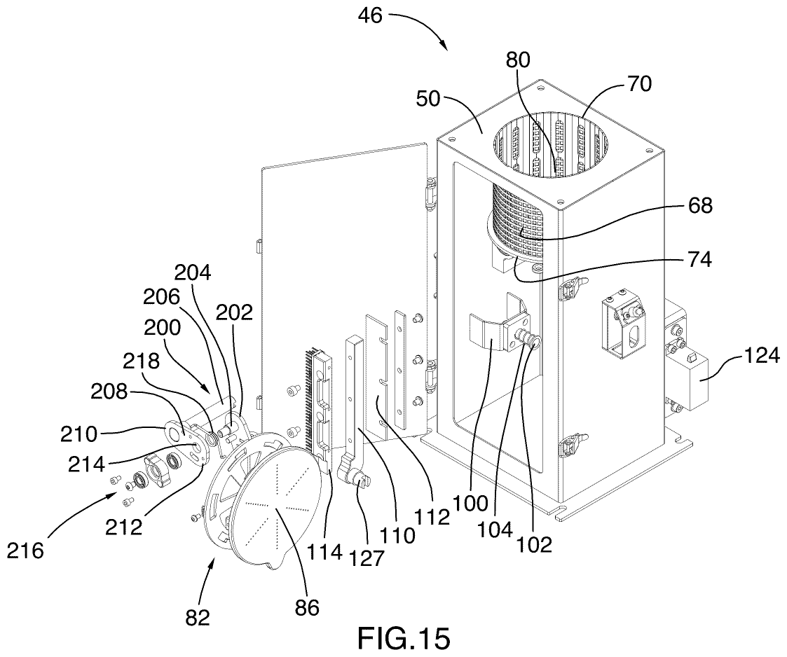

Referring to FIGS. 14 and 15, the plate 82 is connected to the first servo motor 120 by a mounting mechanism 200 according to another embodiment. The plate 82 comprises a plate base member comprising a plate projection 202 with a connecting extension 204 extending along a transversal or horizontal axis that intersects the longitudinal or vertical axis 48 of the box 46. The mounting mechanism 200 also comprises a mounting arm 206 extending along a transversal or horizontal axis that intersects the longitudinal or vertical axis 48 of the box 46 with a mounting projection 208 extending inwardly transversely from the mounting arm 206 between a first end 210 and a second end 212. The second end 212 of the mounting projection 208 defines an aperture 214 for receiving the connecting extension 204 of the plate projection 202 and the mounting mechanism further comprises a locking mechanism 216 for affixing the plate 82 to the mounting projection 208 of the mounting arm 206 while a biasing member 218 biases the plate 82 in the first position shown in FIG. 14 wherein the plate 82 abuts against the outlet end wall 74 of the box conduit 68 and wherein a biasing force is applied by the biasing member 218. The biasing member 218 may be a spring.

It is understood that the mounting arm 206 is operatively connected to the first servo motor 120 such that pivoting movement of the plate between the first and second positions is allowed by activation and deactivation of the first servo motor 120.

Referring to FIG. 16, the insect monitoring system 10 comprises a camera subsystem 138 comprising a camera 140 adapted to capture high resolution images of the top surface 86 of the plate 82 in the first position. The camera 140 may be adapted to capture images having a resolution of 1,944 width and 1,944 height in pixels. The camera subsystem 138 comprises a power cable 142 connected to the camera 140 and an energy source (not depicted), a lens assembly 144, a cover glass 146 to prevent insects sticking on the lens assembly 144, a cover glass holder 148 that is removeable for periodical cleaning, a camera holder 150, a base plate 152 and a lighting array 160. It should be understood that the lighting array 160 of the camera subsystem 138 is separate and distinct from the aforementioned luring lamp previously described hereinabove. While one particular location and configuration for the placement of the lighting array 160 is shown, the array of LEDs may be located in any suitable location to enable adequate illumination of the top surface 86 of the plate 82 in the first position without straying from the intended scope of the present invention.

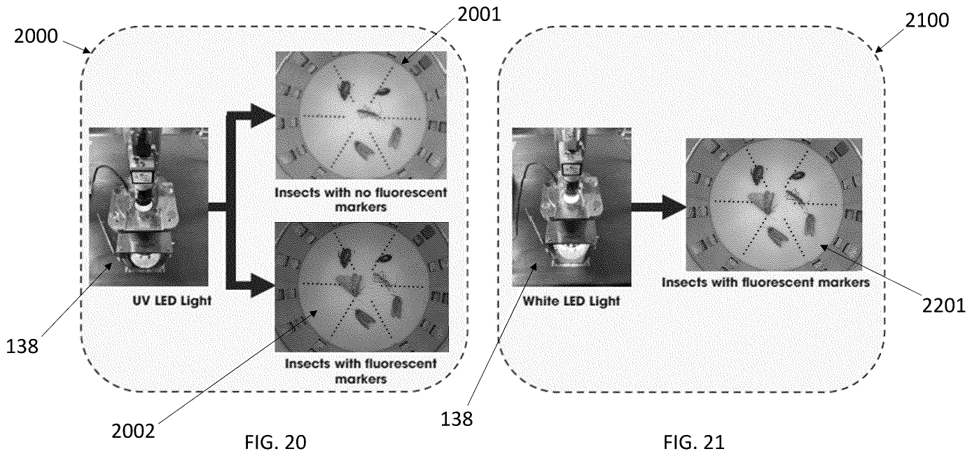

The lighting array 160 includes one or more LEDs 161, 162. It should be noted that some of the LEDs 161 may emit white light to provide lighting for the camera 140 when the camera 140 is activated to capture standard images of insects maintained against the top surface 86 of the plate 82. Additionally, some of the LEDs 162 may emit UV light to capture enhanced images of insects maintained against the top surface 86 of the plate 82. In other words, when the camera subsystem 138 is in place within the assembled insect monitoring system as, for example, in FIG. 1, the LEDs 161, 162 are able to selectively emit either white light or UV light from the lighting array 160 through the receptacle moving area 80 and onto the top surface 86 of the plate 82 where captured insects will exist during use of the assembled insect monitoring system. Such selective emission of either white light or UV light from the lighting array 160 will be further described hereinbelow with additional reference to FIGS. 20 to 27.

The camera 140 may have a wired or wireless connection to electronic devices for transmission and/or recording of images. The top plate 96, the cover glass holder 148, the camera holder 150, and the base plate 152 may be made of aluminum or stainless steel.

It is understood that the insect monitoring system comprises one or more conduits, tubes or pipes defining one or more moving areas for the insects attracted by the light source 12 move into the one or more moving area, a housing or receptacle being part of one or more of the conduits, tubes or pipes, or being an additional component, the housing or receptacle being adapted to receive the insects being pushed therein or thereon by airflow generated by a compressed air source or a fan, and a camera to capture images of one or both the plate and the insects. The insect monitoring system may comprise a plate comprising a bottom surface and a top surface for receiving the insects and being movable between a first position, wherein the plate abuts against an outlet end wall and downward pressure is applied by the airflow for maintaining in place the insects on the top surface of the plate, and a second position, wherein the plate no longer abuts against the outlet end wall and the top surface of the plate is entirely accessible insects. The insect monitoring system may comprise a cleaning member adapted to contact to and move over the top surface of the plate for one or both cleaning the top surface of the plate and removing insects located on the top surface of the plate when the plate is in the second position. The insect monitoring system may comprise a fluid source is adapted to generate a spray of fluid towards the top surface of the plate when the plate is in the second position.

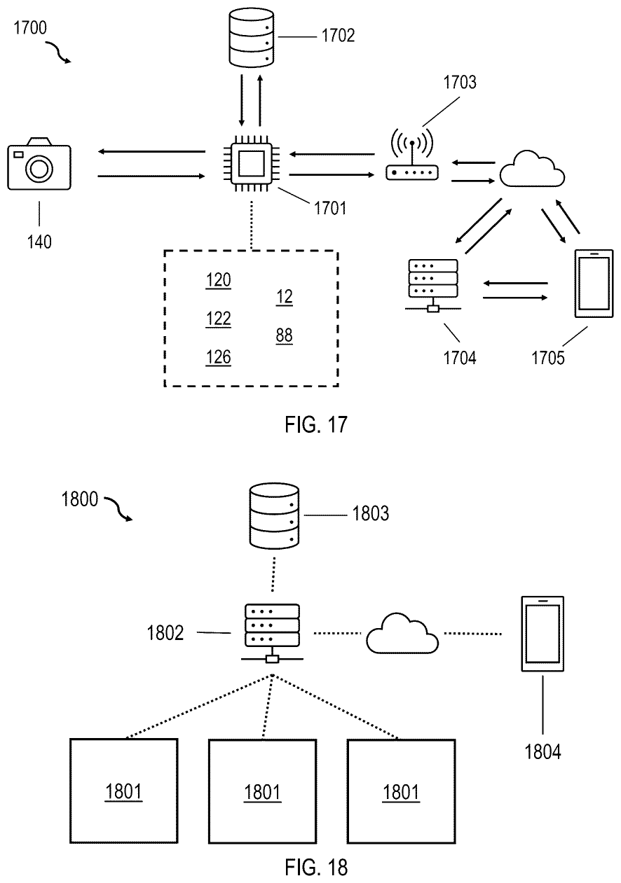

Referring now to FIG. 17, an exemplary insect monitoring system 1700 comprising on-board data acquisition, data processing, data storage and/or data provision means is presented.

According to a broad aspect of the present disclosure, an insect monitoring system 1700 may comprise lure means for attracting insects and an insect inlet. The lure means may be any acceptable means for attracting insects, for example a visible light source such as the light source 12, a UV light source, an infrared light source, a source of carbon dioxide, a pheromone source, a source of hydrogen sulfide, or a source of other compounds, gases, smells and/or aerosols that attract insects. The lure means may be designed for attracting a broad population of insects, for example the lure means may be non-insect-specific, for example a light source. Accordingly, such a lure means may generally attract a cross-section of an insect population present in an area. For example, a broad-scope lure means may attract flies, mosquitoes, wasps, moths, and pests. The lure means may comprise one or more means for attracting insects. For example, the lure means may comprise both a light source and a pheromone source, or any other acceptable combination of lure means.

Accordingly, the insect monitoring system may monitor and catch both a cross-section of a general insect population present in an area, as well as a target insect population of interest. For example, an insect monitoring system may comprise a broad-scope lure means for attracting a local insect population in general, and a targeted lure means for attracting insects whose presence may be particularly desirable or undesirable, for example pollinators and/or locusts. Accordingly, an insect monitoring system according to the present disclosure may monitor general insect populations across and area, and act as an early warning system for a potential locust infestation. It is understood that combinations of lure means may be adapted to monitor and/or detect a variety of insect species.

It is understood that the lure means may be proximate to the insect inlet, thereby causing insects to be attracted in a general direction towards the insect inlet. Accordingly, the insects so attracted may be further captured, retained and/or monitored according to the principles disclosed herein.

The insect monitoring system according to the present disclosure may also comprise insect retention means for collecting insects having been captured. It is understood that any appropriate insect retention means that causes at least a partial restriction of insects'movement may be used. For example, the insect retention means may be a mesh. The insect retention means may be a plate, for example a plate 82 as described above.

The insect monitoring system may comprise a body defining a conduit extending between the insect inlet and the insect retention means. The conduit may be of an appropriate shape and/or length for operating the insect monitoring system. For example, a compact insect monitoring system may comprise a shorter conduit. An insect monitoring system may comprise a longer conduit, for example for extending the insect inlet a predetermined distance or height from the ground, from the vegetation or from the insect monitoring system.

The insect monitoring system may comprise air displacement means for directing an airflow in a direction from the insect inlet to the insect retention means. The air displacement means may be a fan, a compressor, or any other means suitable for creating an airflow directing the insects having been attracted towards the insect inlet to the insect retention means. For example, the air displacement means may be the compressor 88. It is understood that the air displacement means may cause a sufficient airflow between the insect inlet and the insect retention means to prevent insects from escaping from the insect retention means and out of the insect inlet.

The insect monitoring system may comprise at least one digital camera, such as the camera 140, configured for capturing at least one of: images of the insect retention means and video of the insect retention means. For example, the digital camera may take one or more pictures of the insect retention means at predetermined intervals, or in response to an indication, for example a request to take a picture, for example a request initiated by a user at a user device and provided to the insect monitoring system over a network.

The insect monitoring system may comprise cleaning means for removing the insects from the insect retention means. The cleaning means may be any acceptable means for displacing insects from the insect retention means, for example causing the insects to be released to a collection means, for example a collection bin or a collection bucket. Accordingly, the cleaning means may be a blade, a brush, a moveable member, and/or cleaning means configured for delivering a fluid to the insect retention means, for example one or more spray heads and/or one or more spray nozzles. It is understood that a combination of the cleaning means as provided above may also be used. For example, the cleaning means may comprise a spray head for spraying water or another fluid on the insect retention means and a brush configured to brush insects off the insect retention means. For example, the cleaning means may comprise the fluid source 126 and one or more cleaning members or brushes.

The insect monitoring system may comprise a processor 1701 and a non-transient storage medium 1702 operatively connected to the processor comprising computer-readable instructions. The processor may be operatively connected to the lure means, to the digital camera, to the cleaning means, and to one or more motors, switches, or other means for actuating, activating and/or operating the features of the insect monitoring system, for example to servo motors 120 and 122, fluid source 126, compressor 88 and light source 12.

The processor may be configured, upon executing the instructions, to acquire at least one of the images and video of the insect retention means. For example, the processor may be configured to send, to the digital camera, an indication corresponding to instructions to capture one or more images of the insect retention means and provide the images to the memory and/or the processor. The processor may be configured to acquire video of the insect retention means. The video may be a video capture over a discrete time, for example between 1 and 60 seconds, or between 1 and 30 seconds, or between 1 and 5 seconds. The video may be a continuous and/or live capture, whereby the camera may, in response to an indication, begin acquiring and continuously acquire a video of the insect retention means and provide the video to the memory and/or the processor, and cease acquiring the video upon receiving an indication to that effect. It is understood that communication between the camera and the processor may be accomplished over any acceptable means, for example cables, such as USB cables, or wireless transmission protocols.

The processor may be further configured to perform a recognition of at least one insect species in the at least one image or video of the insect retention means. The performing may comprise applying a Machine Learning Algorithm (MLA) or other artificial intelligence (AI) means to the acquired image, images, or video, wherein the MLA may be provided with a knowledge base of insect species and factors for recognizing one or more of the insect species in an image or a video. It is understood that the MLA and/or the database and/or the knowledge base may be comprised in the non-transient storage medium 1702, and/or a separate storage medium, for example a separate memory operatively connectable or operatively connected to the processor 1701.

The processor may be further configured to perform a count of insects of the at least one insect species in the at least one image or video of the insect retention means. The performing of the count may comprise providing the same MLA or AI means as above, or other counting means, and counting recognitions performed as above.

The processor may be further configured to evaluate a density of the insects in the at least one image or video of the insect retention means.

It is understood that the MLA and/or AI means may comprise further functionalities such as data sampling and/or data smoothing. For example, where the MLA and/or AI means is configured to recognize and/count a species in video, the MLA and/or AI may be configured to periodically sample the video for recognizing and/or counting the species, and/or to smooth data related to the recognition and/or to the count to account for variations between different sampled portions or times of the video. Other appropriate data processing functionalities will be apparent to the skilled person.

The processor may be further configured to provide, over a network, an indication corresponding to at least one of the recognition, the count, and the density. For example, the processor may be configured to provide to a server 1704, through networking means 1703, such as a modem, a router, a transceiver, or other acceptable transmission and/or reception means, for example a remote data server, data related to species recognitions, counts and/or insect densities. It is understood that the data may be further associated with time data, such as a collection and/or sampling time, and/or with location data, for example a GPS location, and/or with an identifier associated with the insect monitoring system for correlating the data provided to the server 1704 with the on-board insect monitoring system having provided the data.

The processor may be further configured to provide the one or more images and/or video acquired by the digital camera over the network. For example, the processor may be configured to provide a video feed of the insect retention means over a network to a user device 1705. The user device may be a smartphone operating an application configured for providing an indication corresponding to a video feed transmission request to the processor 1701 and causing the video feed received over the network to be displayed on the user device.

The processor may be further configured to, in response to the density exceeding a predetermined threshold, actuate the cleaning means, for example the cleaning member 106 and/or the fluid source 126. For example, the processor may be configured to actuate the cleaning means, and/or initiating a cleaning sequence, for example a sequence comprising actuating a cleaning member and a fluid source as described above. For example, in a non-limiting embodiment, the insect retention means, for example the plate 82, may be pivotably mounted for switching between an open position and a closed position for selectively obstructing the passage of insects through the conduit when in the closed position, and the cleaning means may be configured for cleaning the insect retention means when in the open position. Accordingly, the processor may be configured to cause the insect retention means to transition to the open position, actuate the cleaning means and, upon completion of the cleaning sequence, cause the insect retention means to return to the closed position.

The predetermined threshold may be 60%, i.e., wherein about 60% of a surface area of the insect retention means is occupied by insects. It is understood that, depending on local conditions and/or sampling and/or monitoring requirements, the threshold may be set to a value between 1% and 99%, for example between 5% and 80%, between 10% and 75%, between 20% and 60%, and/or between 30% and 50%

The insect monitoring system may comprise additional sensing means for collecting data. For example, the insect monitoring system may comprise weather sensors, for example a rain sensor and/or a rain meter, a wind sensor and/or meter, a temperature sensor, and/or a humidity sensor. It is understood that data collected by the additional sensing means may be stored in the non-transitory storage medium 1702, provided to the processor 1701 for processing, have a MLA and/or other AI means applied thereto for processing the data, and provided over a network, for example over a wireless network, to a remote server.

Referring now to FIG. 18, the on-board insect monitoring system as described above may form part of an insect monitoring network 1800. For example, a plurality of insect monitoring systems 1801, such as one or more of the insect monitoring system 10 and/or one or more of the on-board insect monitoring system 1700 as described above may be provided in several locations, for example in one or more farming fields, proximate to water features, for example along one or more lakes or rivers, or generally across a region.

The insect monitoring network may comprise a server 1802 configured to receive the indications and/or data from the plurality of insect monitoring systems. The server 1802 may be configured to store the indications and/or data in a memory 1803. The server 1802 may be further configured to provide, over a network, at least a portion of the data and/or indications so received to one or more user devices 1804. It is understood that user devices 1804 may be configured to operate means for interacting with the server 1802, for example a companion application. For example, the user devices 1804 may interact with the server 1802 through a browser interface, or through other acceptable means that will be apparent to a skilled person. Accordingly, a user may request data, such as whether an insect species is present, or its incidence, from the server 1802, and may furthermore specify the insect monitoring system for which such data is sought. Furthermore, the user may cause the server to provide to the user device one or more images and/or a video acquired by the digital camera, for example by the at least one digital camera of a chosen insect monitoring system 1801.

It is understood that the user may also request that an image or a video be acquired, and accordingly one or more insect monitoring systems 1801 would cause the respective digital camera to acquire the one or more imager or the video regardless of a predetermined sampling interval. For example, an insect monitoring system 1801 may be configured to capture an image every minute, or every 5 minutes, or every 10 minutes. Upon receiving a request from the server 1802 corresponding to a request from a user device for an image or for a video, the processor, for example processor 1701 or insect monitoring system 1700, overrides instructions corresponding to a sampling interval and causes the digital camera to acquire an image or a video. It is understood that the user may request a live feed from an insect monitoring system and the server 1702 may be configured to provide a live video feed from a digital camera to the user device.

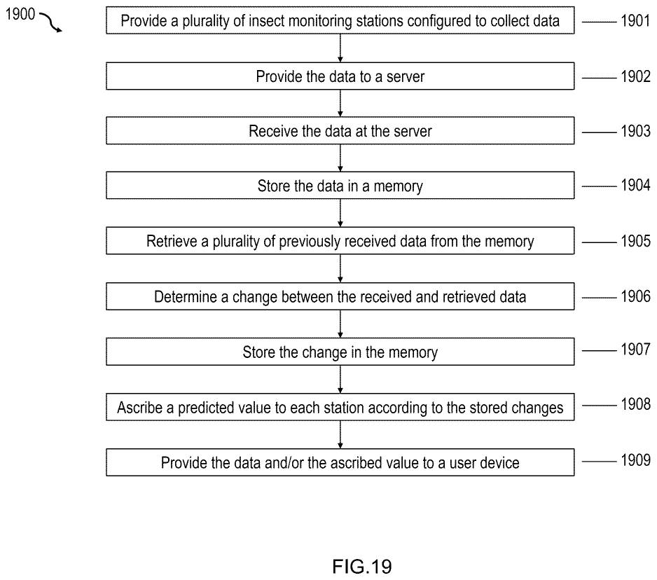

Referring now to FIG. 19, a method 1900 for monitoring and predicting insect populations across a plurality of locations is presented. The method comprises providing a plurality of insect monitoring stations (1901). The stations may be insect monitoring stations according to the principles disclosed herein, for example the insect monitoring system 10 and/or the on-board insect monitoring system 1700 as described above.

The stations may be configured to collect data, the data being related to at least one of a presence of at least one insect species, a number of insects of the at least one insect species, and a total number of insects. Accordingly, the stations may collect data indicating a first detection of an insect species at the station. The stations may collect data indicating a growth or a reduction in the population of the insect species, for example a growth of the number of pests or a fall in the number of pollinators. The stations may collect data indicating an overall growth or reduction of the insect population, providing an indication of changes in the local ecosystem.

It is understood that the stations may collect other data, for example data related to weather conditions, soil conditions and others. For example, the stations may collect data related to wind speed, wind direction, temperature, humidity, hours of sunlight and rainfall.

The data collected by the stations may be associated with a time of gathering, a location of the station, and other indicators appropriate for identifying the origin of the data.

The stations may comprise a processor configured to provide, over a network, the data to a server (1902). The processor may be, for example, the processor 1701, or any processor suitable for the purpose. The server may be a remote server, for example a data center. The providing may comprise providing the data over a wireless network, for example over a mobile network, a Bluetooth network, a Wi-Fi network, or other appropriate networks.

The method may comprise receiving the data by the server (1903) and storing the data in a memory (1904). It is understood that the memory may be a physical memory operatively connected to the server, or a cloud-based storage solution, or other memory means apparent to the skilled person.

The method may comprise retrieving, by the server, a plurality of previously received data from the memory (1905). The server may retrieve data associated with the same station as the data being received, wherein the retrieved data is associated to one or more different times of gathering. The server may retrieve data associated with other stations and with a time of gathering substantially proximate to the time of gathering of the data being received.

The method may comprise determining, for each station, a change between the data received from the station and the data associated with a different time of gathering (1906) and storing the determined change in the memory (1907). For example, the determining may comprise determining whether an insect species has become present at a given station, or whether its population has changed. The determining may comprise determining a change in wind speed, rainfall, humidity, or other relevant weather parameters. The changes so determined may be stored in a memory, which may be the same memory as in step 1905, or a different memory. For example, the memory at 1907 may be a local physical memory while the memory at 1905 may be a cloud-based memory.

The method may comprise ascribing, to each station, a predicted value for the data based on the stored determined changes and the locations for the plurality of stations (1908). The server may be configured to provide data processing and/or analysis means, for example a Machine Learning Algorithm (MLA), for recognizing trends in the data collected from the plurality of stations at a plurality of gathering times, and/or for determining trends for the changes previously determined at 1906. For example, in a non-limiting embodiment, a MLA may recognize potential a locust migration by determining a trend according to the position of a plurality of stations, changes in data related to the presence of locusts for that plurality of stations, changes in data related to the number of locusts for that plurality of locations, as well as wind speed. Accordingly, the MLA may output a predicted value of locust presence and/or locust number for one or more insect monitoring stations, according to one or more factors. The factors may comprise a directionality of the detected changes determined according to the location of each of the plurality of stations for which a trend has been recognized, the speed of the change determined based on the times of gathering, a magnitude of the changes determined for the plurality of stations, and weather factors, for example wind speed. Accordingly, a system implementing the method may provide relevant, targeted locust migration predictions based on a plurality of factors, including both microclimatic and macroclimatic factors. For example, local wind direction at a station may affect the ascribed predicted value according to a determined influence of wind direction and/or speed on the speed and intensity of a locust migration.

The method may comprise providing at least one of the data and the predicted value to a user device (1909). The user device may be a user device as described above, for example user device 1705 and/or 1804, and it is understood that the method 1900 may be implemented in an insect monitoring network as described above, for example an insect monitoring network 1800. Accordingly, a user device may receive data regarding predicted insect populations or migration patterns across a geographical region, or for a single station, or for a plurality of stations. For example, the user device may be a computer, the user may be an agricultural officer and the provided data and/or the predicted value may encompass a broader region, for example the predicted value may be a predicted presence of locusts in the region.

The user device may be a smartphone, the user may be a farmer and the data and/or the predicted value may be a predicted presence of locusts at a station proximate to the farmer's operations, fields, storage facilities and/or other infrastructure. Accordingly, a farmer may receive a relevant and/or reliable advance warning of a possible insect infestation, thereby allowing for increased response time to minimize the impact of the infestation. For example, the farmer may anticipate harvesting of the field or fields predicted to be affected, or provide shielding or isolation means for the crops, or seal storage facilities, or take other appropriate actions as deemed necessary.

At least one of the memories implementing the method 1900 may comprise data related to insecticides. In some embodiments, the method comprises determining if the predicted value ascribed to a station exceeds a predetermined threshold and, in response to the predicted value exceeding the predetermined threshold, providing, to a user device, an indication corresponding to a recommendation to spread insecticides. For example, the ascribed value may be a prevalence of pests above a certain threshold, for example above a certain proportion of the overall insect population at the station. In other embodiments, the ascribed value may be the presence of a species, for example locusts, and accordingly the threshold may be very low, for example any value exceeding zero. Accordingly, a user device may receive and cause to be displayed to a user a recommendation to proactively spread insecticides in response to the ascribed value exceeding the predetermined threshold.

In some embodiments, data related to insecticides may be further related, for one or more insecticides, to one or more species of insects. For example, the data may comprise data relating a species-specific insecticide that spares other insect species, for example pollinators. In some embodiments, a user device may accordingly be provided with an indication corresponding to a recommendation to spread a particular insecticide associated to the species for which the ascribed value or the data have exceeded the predetermined threshold.

It is understood that the data may be provided to the user device according to a schedule, for example as a daily update, or in response to a request by the user. It will also be understood that the data, the ascribed value and/or an indication may be provided to the user device as the data and/or the ascribed value are received, processed and/or analyzed at the server. For example, an indication corresponding to an ascribed value of the presence of locusts exceeding zero may be provided to the user device as a push notification. Other means for providing time-sensitive information will be apparent to the skilled person.

With further reference to FIG. 16 and additionally with reference to FIGS. 20 through 28, the insect migration monitoring system and method will now be described in further detail. With specific regard to FIG. 16, the LEDs 161, 162 of the lighting array 160 may selectively emit white visible light (i.e., within the range of approximately 400 nm to 700 nm wavelength) or UV (e.g., 345 nm wavelength). Although two distinct sets of LEDs 161, 162 are shown, it should be understood that this may be accomplished by one or more LEDs having tunable wavelengths and/or one or more LEDs having dedicated, static wavelength outputs in the selected light regions (e.g., UV or white light). The LEDs 161, 162 emit light to provide lighting for the camera 140 when the camera 140 is activated to capture images of insects maintained against the top surface 86 of the plate 82. Depending upon whether white light is used or whether UV light is used, the insects may be illuminated in different manners.

In particular, previously tagged and released insects that are subsequently recaptured by the insect monitoring system are identifiable under UV light when previously tagged with a UV reactive mechanism. It should be understood that such UV reactive mechanisms that are contemplated within the present disclosure may include spraying or otherwise coating insects with a fluorescent dust, dye, fluid, or any otherwise suitable marking material. Likewise, such UV reactive mechanisms may further include genetic modifications to insects including, but not limited to, gene editing to provide for the eyes or other parts of the insect body to illuminate under UV light exposure.

The present disclosure therefore contemplates using the one or more LEDs 161, 162 of varying wavelengths and corresponding camera subsystem 138 within the insect monitoring system for the method of identifying previously fluorescently tagged insects. Advantageously, the known mark-release-recapture method is greatly improved by way of the inventive insect monitoring system whereby either migration or dispersion of insects within any wild habitats may be tracked and monitored over time and over various geographies and topologies. Thus, the insect migration monitoring system and method provides an improved manner of determining where and when specific insects may be found in a range of locations and habitats.

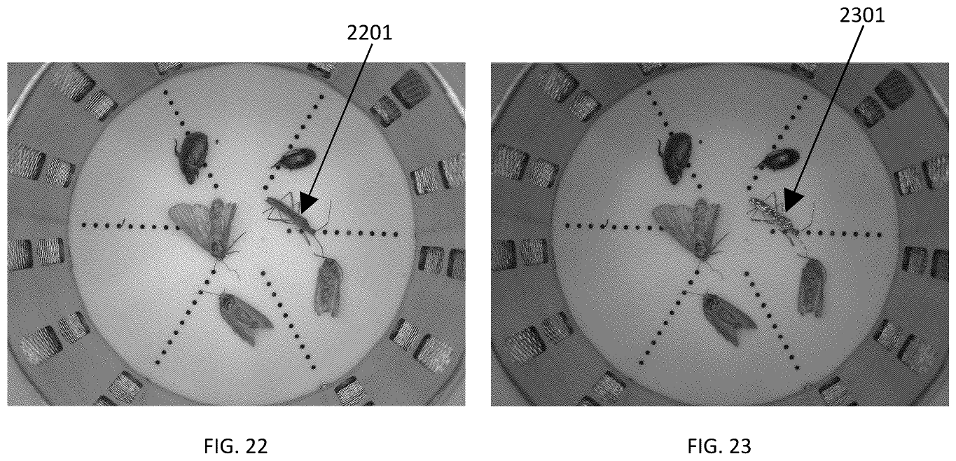

With specific reference to FIGS. 20 and 21, there are illustrated two photographic scenarios 2000, 2100, respectively, when the LEDs 161, 162 selectively emit from the lighting array 160 of camera subsystem 138 either UV light in scenario 2000 or white light in scenario 2100. In the instance of UV light being applied to the plate upon which top surface captured insects are located, the insects having fluorescent markers differs in appearance (i.e., by fluorescent glow) from insects with no fluorescent markers. However, in the instance of white light being applied, there would of course be no indications of identifiable markings (i.e., by fluorescent glow) for insects with fluorescent markings. This is more clearly evident by way of FIGS. 22 and 23 which show enlarged images of the identical grouping of insects under white and UV light, respectively. Here, it is readily apparent that the target insect 2201 under white light fails to reveal any identifiable marker while the same, yet UV illuminated, target insect 2301 shows glowing speckles under UV light. Thus, while white light is useful for camera-aided insect identification purposes, UV light provides an enhanced methodology for identifying specific known insects that have previously been marked by any given UV reactive mechanism as previously discussed above. When combined with time-stamped data corresponding to the time of identification along with geocoded data corresponding to a geographical location of the camera subsystem, the camera-aided identification of insects with fluorescent markings in accordance with the present disclosure may yield patterns of insect movement. It should be noted this enhanced methodology is advantageous in the context of monitoring migration patterns and/or biological dispersion of insects in a variety of habitats.

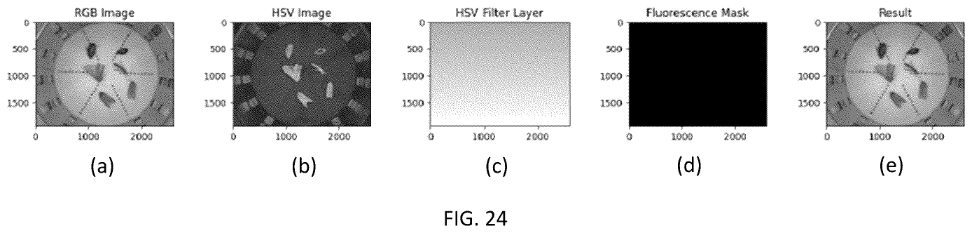

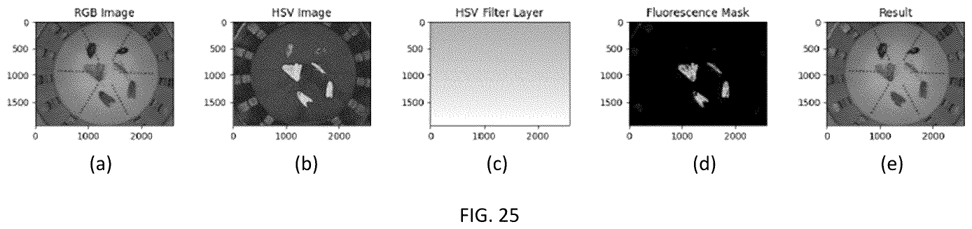

As suggested above with regard to FIGS. 20 and 21, the enhanced methodology for identifying specific known insects that have previously been marked by any given UV reactive mechanism begins with capturing insect images under UV light and white light. Once the camera captures these images under UV light and white light via the aforementioned on-board data acquisition processors, such digital images undergo data processing to apply HSV (hue, saturation, value) filtering as computer graphic representations of the known RGB (red, blue, green) color model. FIG. 24 (a) through (e) illustrates the process of applying HSV filtering with regard to a captured image with no fluorescent markers, while FIG. 25 (a) through (e) illustrates the process of applying HSV filtering with regard to a captured image including fluorescent markers.

Stepping through FIG. 24, there is shown (a) the processed RGB image of the captured insects without any fluorescent markers and (b) the processed HSV image of these captured insects whereupon (c) applying an HSV filter layer and (d) a fluorescence mask thereby provides a resultant processed image at (e). As is readily apparent, no digital indications of the presence of fluorescence are present. However, stepping through FIG. 24, there is shown (a) the processed RGB image of the captured insects now having fluorescent markers and (b) the processed HSV image of these captured insects whereupon (c) applying an HSV filter layer and (d) a fluorescence mask thereby provides a resultant processed image at (e) which clearly indicates areas of fluorescence useful in a machine learning pipeline.

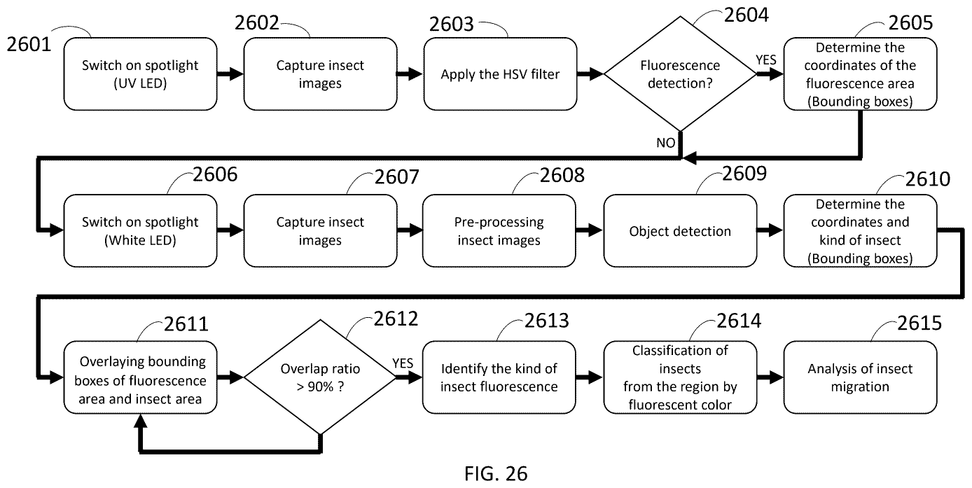

With reference to FIG. 26, a machine learning pipeline is illustrated in accordance with one embodiment of the present insect migration monitoring system and method. As previously mentioned hereinabove, the processor of the present system and method is configured to perform a recognition of at least one insect species in the at least one image or video of the insect retention means and may comprise applying an MLA or other AI means to the acquired image, images or video, wherein the MLA may be provided with a knowledge base of insect species and factors for recognizing one or more of the insect species in an image or a video. In the context of insects previously tagged with a UV marking mechanism, such tagging information would be among such factors as illustrated in the MLA pipeline of FIG. 26 correlating to migration monitoring.

As shown in FIG. 26, the UV lighting element in the form of one or more LEDs is first switched on (at step 2601) whereby the camera then captures (at step 2602) the insect images. Application of the HSV filtering (at step 2603) is then made to this first processed image as previously discussed with regard to FIGS. 24 and 25. The result of the HSV filtering is then a decision (at step 2604) which determines whether or not fluorescence is detection. If such fluorescence is indeed detected, then the coordinates of the area fluoresced (i.e., the bounding boxes of the fluorescence on the captured image) is then determined (at step 2605). Thereafter, and if no such fluorescence is detected, the MLA pipeline will continue so as to then switch (at step 2606) to a white lighting element (rather than the UV lighting). Again, the camera will capture (at step 2607) and pre-process the insect images (at step 2608) though now under white lighting conditions. Under such white lighting conditions, detection of objects on the plate will occur (at step 2609) so as to determine the coordinates (at step 2610) and, in coordination with the knowledge base as mentioned above, the given type of insect among the objects on the plate whereby related bounding boxes are generated with regard to this second processed image.

The MLA pipeline then further provides an overlay function (at step 2611) to the first processed image with bounding boxes of fluorescence areas overlayed with the second processed image with bounding boxes of the identified insect(s). Once it is determined (at step 2612) that the overlap ratio exceeds 90%, then the identification of the kind of insect fluorescence (e.g., dust, dye, fluid, genetic modification, etc.) is determined (at step 2613). In coordination with the knowledge base, classification of the insects from the region is determined (at step 2614) by the fluorescence particulars (e.g., color, body part placement, etc.). Thereafter, in coordination with information from the knowledge base relating to the data sets of previously tagged insects including their location of initial release and last know location of previous monitoring, the MLA pipeline then provides (at step 2615) an analysis of any given identified insect's patterned movement over time (i.e., path of migration, insect dispersion). It should be noted that this processed information may then be network distributed to one or more users so as to provide both real-time migration monitoring and historical data patterning. In this manner, predictive information may be provided to, for example, advantageously aid in pesticide inventorying and IPM overall thereby more effectively minimizing waste, improper pesticide applications, and substantially eliminating pesticide overuse.

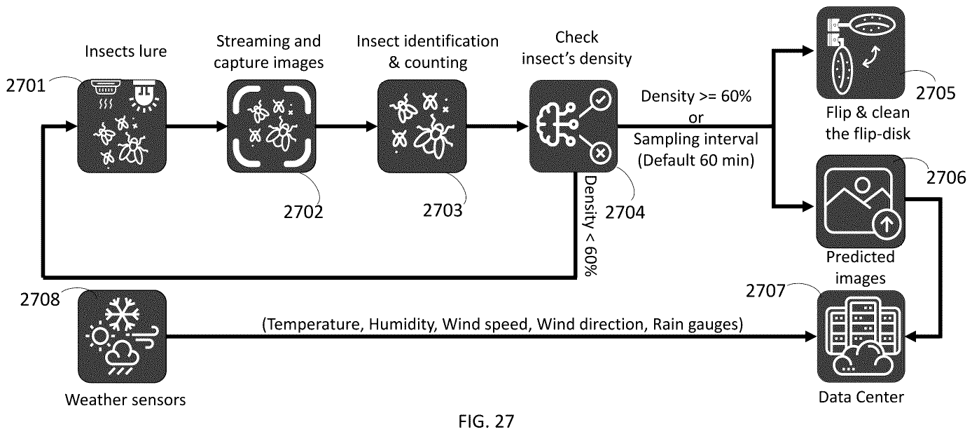

With reference to FIG. 27, the overall operating procedure of the present insect migration monitoring system with particular regard to its corresponding edge computing process is shown and described. Here, it may be seen that insects are first lured (at block 2701) to the monitoring system whereby streaming video and/or images are captured (at block 2702) to then produce insect identification and counting (at block 2703) which continues until insect density meets or exceeds 60% in the given sample over a given sampling interval (at block 2704). The default sample interval being 60 minutes though it should be understood that custom settings for such interval may vary in accordance with the given field conditions and user-defined periods without straying from the intended scope of the present disclosure. The given sample is then analyzed (at block 2706) as previously discussed with regard to the MLA pipeline and the monitoring system cleaned (at block 2706). Beyond the point of edge computing in the field, the imaging analysis this then uploaded to the cloud data center (at block 2708) for further processing in conjunction with external sensors and information (at block 2709) including, e.g., temperature, humidity, wind speed and direction, rain, and the like.

It should be further understood that the MLA pipeline in terms of the present insect migration monitoring system and method may involve, as is known in the machine learning art, a server which obtains a set of machine learning (ML) models by performing a model initialization procedure to initialize the model parameters and model hyperparameters of the set of ML models. The model parameters are configuration variables of a machine learning model, and which are estimated or learned from training data, i.e., the coefficients are chosen during learning based on an optimization strategy for outputting a prediction according to a prediction task. Learning in the present context may of course include the iterative process of UV detection of migrating, previously tagged insects. Such server may obtain the hyperparameters in addition to the model parameters for the set of ML models. The hyperparameters are configuration variables which determine the structure of a given ML model and how the given ML model is trained.

It will be appreciated that the number of model parameters to initialize will depend on inter alia the type of model and prediction (i.e., classification or regression model), the architecture of the model (e.g., Deep Neural Networks (DNN), Support Vector Machines (SVM), ensemble trees, etc.), and the model hyperparameters (e.g., a number of layers, type of layers, number of neurons in a neural network). In one or more implementations, the hyperparameters may include one or more of: a number of hidden layers and units, an optimization algorithm, a learning rate, momentum, an activation function, a minibatch size, a number of epochs, and dropout. In one or more implementations, training of the set of ML models is repeated until a termination condition is reached or satisfied. As a non-limiting example, the training may stop upon reaching one or more of: a desired accuracy, a computing budget, a maximum training duration, a lack of improvement in performance, a system failure, and the like.

As previously mentioned, it is understood that the MLA and/or the database and/or the knowledge base may be comprised in a non-transient storage medium, and/or a separate storage medium, for example a separate memory operatively connectable or operatively connected to the processor.

The processor may be further configured to perform a count of insects of the at least one insect species in the at least one image or video of the insect retention means. The performing of the count may comprise providing the same MLA or AI means as above, or other counting means, and counting recognitions performed as above.

The processor may be further configured to perform a UV-enabled insect recognition of the at least one insect species in the at least one image or video of the insect retention means. The performing of the UV-enabled insect recognition may comprise providing the same MLA or AI means as above, or other UV-enabled insect recognition means, and UV-enabled insect recognitions performed as above.

The processor may be further configured to perform, in conjunction with UV-enabled insect recognition, further migration and/or dispersion analysis of the at least one insect species in the at least one image or video of the insect retention means. The migration and/or dispersion analysis may comprise providing the same MLA or AI means as above, or other migration and/or dispersion analysis means, and migration and/or dispersion analysis performed as above.

The systems and methods disclosed herein may provide one or more advantages over the prior art.

An advantage of the present disclosure comprises an automated insect monitoring system wherein ongoing insect monitoring may be provided with minimal human intervention, for example by obviating or reducing the need for insect traps.

A further advantage of the present disclosure comprises improved biosecurity, as reduced human intervention in insect monitoring reduces the possibility of pests or pathogens being carried between fields or between regions by monitoring and maintenance staff.

A further advantage of the present disclosure comprises improved precision of insect monitoring, wherein improved cleaning means for an operative surface of the insect monitoring systems allow for clearer recognition of insect species and insect counting on the operative surface, and reducing data noise due to improper, incomplete, or infrequent cleaning.

A further advantage of the present disclosure comprises reduced network bandwidth needs for insect monitoring stations by replacing at least a portion of the network traffic associated with transmitting images and/or video for processing at a data center with more compact, processed data obtained through the on-board processing and/or analysis means.

A further advantage of the present disclosure comprises improved proactive insect management by agricultural and/or environmental stakeholders. The present disclosure provides methods and means for determining and identifying potential threats related to insects, for example infestations, and issuing recommendations targeted to at-risk areas. For example, the present disclosure provides for improved targeting of insecticide spraying. Accordingly, stakeholders may be provided with recommendations for species-specific insecticides that spare desirable species or be provided with proactive recommendations to use broad-spectrum insecticides to prevent a dangerous infestation from spreading from neighboring fields and/or regions.

A further advantage of the present disclosure comprises improved local and regional insecticide inventory management by reducing stakeholders'need to store a broad range and/or a large quantity of insecticides. Furthermore, improved inventory management and reduced idle insecticide storage provide a further advantage comprising improved capacity to respond to insect-related threats at the regional level by assisting in directing supplies where and when they are needed.

A further advantage of the present disclosure comprises improved automation of insect migratory and/or dispersion analysis for networked distribution to one or more users so as to provide both real-time migration monitoring and historical data patterning.

A further advantage of the present disclosure comprises improved analysis and data collection of predictive information such as, but not limited to, more efficient pesticide inventorying and IPM to more effectively minimize waste, reduce improper pesticide applications, and substantially eliminate pesticide overuse.

The above description is considered as illustrative only of the principles of the invention. Since numerous modifications and changes will become readily apparent to those skilled in the art in light of the present description, it is not desired to limit the invention to the exact examples and embodiments shown and described, and accordingly, suitable modifications and equivalents may be resorted to. It is understood by those skilled in the art that throughout the present specification, the term “a” used before a term encompasses embodiments containing one or more to what the term refers. It will also be understood by those skilled in the art that throughout the present specification, the term “comprising,” which is synonymous with “including,” “having” or “containing” is inclusive or open-ended and does not exclude additional, un-recited elements or method steps.

The above description of the embodiments should not be interpreted in a limiting manner since other variations, modifications and refinements are possible within the scope of the present invention. Accordingly, various features and aspects of the disclosed embodiments can be combined with or substituted for one another to form varying modes of the disclosed invention. The scope of the invention is defined in the appended claims and their equivalents.

1. An insect monitoring system, the system comprising:
lure means for attracting insects;
an insect inlet proximate to the lure means and for capturing insects;
insect retention means for collecting insects having been captured;
a conduit extending between the insect inlet and the insect retention means;
air displacement means for directing an airflow through the conduit in a direction from the insect inlet to the insect retention means;
a camera subsystem including,
at least one digital camera configured for capturing at least one of: images of
the insect retention means and video of the insect retention means, and
a lighting array configured to selectively emit ultraviolet and white light;
an on-board processor; and
a non-transient storage medium operatively connected to the processor including computer-readable instructions, wherein the processor is configured, upon executing the instructions, to:
acquire, under ultraviolet light provided by the lighting array, a first digital representation of the images and video of the insect retention means;
perform a fluorescence recognition of fluorescence emitted by the at least one insect type in the first digital representation;
apply coordinates corresponding to a detected fluorescence within the first digital representation;
acquire, under white light provided by the lighting array, a second digital representation of the images and video of the insect retention means;
perform a type recognition of detected insect types among the at least one insect type in the second digital representation;
apply coordinates corresponding to the detected insect types within the first digital representation; and
identify, by comparison of the first digital representation with the second digital representation, all insect types emitting fluorescence.

2. The system according to claim 1, wherein the processor is further configured to
generate geocoded data corresponding to a geographical location of the camera subsystem,
perform a count of each insect type emitting fluorescence, and
provide, over a network, the geocoded data along with the count and type of each insect type emitting fluorescence.

3. The system according to claim 2, further including a cleaning means for removing insects from the insect retention means, and
wherein the processor is further configured to
evaluate a density of the insects in the at least one image or video of the insect retention means,
provide, over the network, an indication corresponding the density, and in response to the density exceeding a predetermined threshold, actuate the cleaning means.

4. The system according to claim 3, wherein the lighting array includes one or more light emitting diodes.

5. The system according to claim 3, wherein the lighting array includes at least one light emitting diode having a tunable wavelength in the range of 345 nm to 700 nm .

6. The system according to claim 3, wherein the lighting array includes at least one light emitting diode having a wavelength in the range of 345 nm to 399 nm and at least one light emitting diode in the range of 400 nm to 700 nm .

7. The system according to claim 2, wherein the performance of fluorescence recognition is configured to recognize an ultraviolet reactive mechanism pre-applied to one or more tagged insects.

8. The system according to claim 7, wherein the ultraviolet reactive mechanism includes at least one of: a fluorescent dust, a fluorescent dye, and a fluorescent fluid.

9. The system according to claim 8, wherein the ultraviolet reactive mechanism includes a genetic modification of the one or more tagged insects.

10. The system according to claim 2, further including at least one of: a rain sensor, a wind sensor, a temperature sensor, and a humidity sensor.

11. The system according to claim 2, wherein the lure means comprises a light.

12. The system according to claim 2, wherein the lure means comprises a pheromone diffuser.

13. The system according to claim 2, wherein the processor is further configured to provide the at least one of the images and video of the insect retention means over the network.

14. The system according to claim 2, wherein the instructions comprise a machine learning algorithm for recognizing insects.

15. An insect monitoring network comprising,
a plurality of insect monitoring systems according to claim 2,
a server, configured to receive the geocoded data along with the count and type of each insect type emitting fluorescence,
a non-transient storage medium configured to store the geocoded data along with the count and type of each insect type emitting fluorescence, and
wherein the server is configured to provide data to a user device to cause the user device to display a geographical representation of a distribution pattern of each insect type emitting fluorescence.

16. A method for monitoring and predicting insect migration across a plurality of locations, the method comprising:
providing a plurality of insect monitoring stations across the plurality of locations, the stations each being configured to collect data, the data comprising at least one of:
a presence of at least one insect type emitting fluorescence;
a number of insects of the at least one insect type emitting fluorescence;
a total number of insects; and
a geographical location of each of the stations;
wherein each of the stations includes a processor configured to provide, over a network, the data to a server, and wherein, for each of the stations, the data is associated a time of gathering;
receiving said data by the server and storing the data in a memory;
retrieving, by the server, a plurality of previously received data from the memory;
determining a distribution pattern for each of the insect types emitting fluorescence based upon the data received from each station and the previously received data associated with a different time of gathering, and storing the distribution patterns in the memory; and
providing at least one of the distribution patterns to a user device to cause the user device to display a geographical representation of a migration pattern for the at least one insect type emitting fluorescence.

17. The method according to claim 16, wherein the data collected at each station is obtained by
acquiring, under ultraviolet light provided by a lighting array, a first digital representation of the images and video of the at least one insect type emitting fluorescence,
performing a fluorescence recognition of fluorescence emitted by the at least one insect species in the first digital representation,
applying coordinates corresponding to a detected fluorescence within the first digital representation,
acquiring, under white light provided by the lighting array, a second digital representation of the images and video of the insect retention means,
performing a type recognition of detected insect types among the at least one insect species in the second digital representation,
applying coordinates corresponding to the detected insect types within the first digital and
identifying, by comparison of the first digital representation with the second digital representation, all insect types emitting fluorescence.

18. The method according to claim 17, wherein the lighting array includes one or more light emitting diodes.

19. The method according to claim 17, wherein the lighting array includes at least one light emitting diode having a tunable wavelength in the range of 345 nm to 700 nm.

20. The method according to claim 17, wherein the lighting array includes at least one light emitting diode having a wavelength in the range of 345 nm to 399 nm and at least one light emitting diode in the range of 400 nm to 700 nm.

21. The method according to claim 17, wherein the performance of fluorescence recognition is configured to recognize an ultraviolet reactive mechanism pre-applied to one or more tagged insects.

22. The method according to claim 21, wherein the ultraviolet reactive mechanism includes at least one of: a fluorescent dust, a fluorescent dye, and a fluorescent fluid.

23. The method according to claim 21, wherein the ultraviolet reactive mechanism includes a genetic modification of the one or more tagged insects.
